(19) United States
(12) Patent Application Publication
(10) Pub. No.: US 2024/0064529 A1
(43) Pub. Date: Feb. 22, 2024

(54) WIRELESS DEVICE, FIRST NODE, AND METHODS PERFORMED THEREBY, FOR HANDLING A FIRST INDICATION

(71) Applicant: Telefonaktiebolaget LM Ericsson (publ), Stockholm (SE)

(72) Inventors: Siva Muruganathan, STITTSVILLE (CA); Andreas Nilsson, GÖTEBORG (SE)

(21) Appl. No.: 18/270,144

(22) PCT Filed: Jan. 18, 2022
(86) PCT No.: PCT/EP2022/050937

§ 371 Date: Jun. 28, 2023

Related U.S. Application Data
(60) Provisional application No. 63/138,560, filed on Jan. 18, 2021.

(51) Int. Cl. H04W 16/28; H04L 5/00; H04B 7/06

(52) U.S. Cl. CPC H04W 16/28; H04L 5/0051; H04B 7/0626

(57) ABSTRACT

A method performed by a wireless device. The wireless device obtains a first indication indicating that non-group based reporting is to be applied to any setting comprising the first indication. The setting indicates how to report, to a respective node, information on one or more respective reference signals to be received from the respective node. The reference signals use one or more respective beams. The wireless device performs measurements on the one or more respective signals. The wireless device then sends, based on the first indication, a non-group based report to a first node, comprising measurements on one or more first respective reference signals received from the first node, and based on the same first indication, another non-group based report to a second node comprising measurements on one or more second respective reference signals received from the second node.

### TECHNICAL FIELD

The present disclosure relates generally to a wireless device and methods performed thereby for handling a first indication. The present disclosure also relates generally to a first node, and methods performed thereby, for handling the first indication.

### BACKGROUND

Wireless devices within a wireless communications network may be e.g., User Equipments (UE), stations (STAs), mobile terminals, wireless terminals, terminals, and/or Mobile Stations (MS). Wireless devices are enabled to communicate wirelessly in a cellular wireless communications network or wireless communication network, sometimes also referred to as a cellular radio system, cellular system, or cellular network. The communication may be performed e.g., between two wireless devices, between a wireless device and a regular telephone and/or between a wireless device and a server via a Radio Access Network (RAN) and possibly one or more core networks, comprised within the wireless communications network. Wireless devices may further be referred to as mobile telephones, cellular telephones, laptops, or tablets with wireless capability, just to mention some further examples. The wireless devices in the present context may be, for example, portable, pocket-storable, hand-held, computer-comprised, or vehicle-mounted mobile devices, enabled to communicate voice and/or data, via the RAN, with another entity, such as another terminal or a server.

The wireless communications network covers a geographical area which may be divided into cell areas, each cell area being served by a network node, which may be an access node such as a radio network node, radio node or a base station, e.g., a Radio Base Station (RBS), which sometimes may be referred to as e.g., gNodeB (gNB), Transmission Point (TP), evolved Node B (“eNB”), “eNodeB”, “NodeB”, “B node”, or BTS (Base Transceiver Station), depending on the technology and terminology used. The base stations may be of different classes such as e.g., Wide Area Base Stations, Medium Range Base Stations, Local Area Base Stations, Home Base Stations, pico base stations, etc . . . , based on transmission power and thereby also cell size. A cell is the geographical area where radio coverage is provided by the base station or radio node at a base station site, or radio node site, respectively. One base station, situated on the base station site, may serve one or several cells. Further, each base station may support one or several communication technologies. The base stations communicate over the air interface operating on radio frequencies with the terminals within range of the base stations. The wireless communications network may also be a non-cellular system, comprising network nodes which may serve receiving nodes, such as wireless devices, with serving beams. In 3rd Generation Partnership Project (3GPP) Long Term Evolution (LTE), base stations, which may be referred to as eNodeBs or even eNBs, may be directly connected to one or more core networks. In the context of this disclosure, the expression Downlink (DL) may be used for the transmission path from the base station to the wireless device. The expression Uplink (UL) may be used for the transmission path in the opposite direction i.e., from the wireless device to the base station.

The third generation partnership project is currently working on standardization of the 5th generation of mobile radio access system, also called Next Generation Radio Access Network (NG-RAN). The NG-RAN may include nodes providing radio connections according to the standard for New Radio (NR), as well as nodes providing radio connections according to the LTE standard. The NG-RAN may need to be connected to some network that may provide non-access stratum functions and connection to communication networks outside NG-RAN, such as the internet.

NR uses Cyclic Prefix Orthogonal Frequency Division Multiplexing (CP-OFDM) in both downlink (DL), that is, from a network node, gNB, or base station, to a user equipment or UE, and uplink (UL), that is, from UE to gNB. Discrete Fourier Transform (DFT) spread OFDM may also be supported in the uplink. In the time domain, NR downlink and uplink may be organized into equally sized subframes of 1 ms each. A subframe may be further divided into multiple slots of equal duration. The slot length may depend on subcarrier spacing. For subcarrier spacing of, Δf=15 kHz, there is only one slot per subframe, and each slot consists of 14 OFDM symbols.

Data scheduling in NR may typically be in slot basis, an example is shown in FIG. 1 with a 14-symbol slot, where the first two symbols may contain physical downlink control channel (PDCCH), and the rest may contain physical shared data channel (PDCH), either physical downlink shared channel (PDSCH) or physical uplink shared channel (PUSCH).

Different subcarrier spacing values may be supported in NR. The supported subcarrier spacing values, also referred to as different numerologies, may be given by Δf=(15×2^{μ}) kHz, where μ∈{0, 1, 2, 3, 4}. Δf=15 kHz may be understood to be the basic subcarrier spacing. The slot durations at different subcarrier spacings may be given by 1/2^{μ} ms.

In the frequency domain, a system bandwidth may be divided into resource blocks (RBs), wherein each may correspond to 12 contiguous subcarriers. The RBs may be numbered starting with 0 from one end of the system bandwidth. The basic NR physical time-frequency resource grid is illustrated in FIG. 2, where only one resource block (RB) within a 14-symbol slot is shown. One OFDM subcarrier during one OFDM symbol interval may be understood to form one resource element (RE).

Downlink transmissions may be dynamically scheduled, that is, in each slot, the gNB may transmit downlink control information (DCI) over the PDCCH about which UE data is to be transmitted to and which RBs in the current downlink slot the data is transmitted on. PDCCH may be typically transmitted in the first few OFDM symbols in each slot in NR. The UE data may be carried on PDSCH. A UE may first detect and decode the PDCCH and if the decoding is successful, it may then decode the corresponding PDSCH based on the decoded control information in the PDCCH.

Synchronization Signal Block (SSB)

SSB may be understood to be a broadcast signal in NR that may aim to providing initial synchronization, basic system information and mobility measurements. The structure of SSB may be found in FIG. 3 and may consist of one Primary Synchronization Signal (PSS), which in FIG. 3 is represented as NR-PSS, one Secondary Synchronization Signal (SSS), which in FIG. 3 is represented as NR-SSS, and a Physical Broadcast CHannel (PBCH), which in FIG. 3 is represented as NR-PBCH. As indicated in FIG. 3, the number of subcarriers is represented in the horizontal axis. The PSS and SSS may be transmitted over 127 sub-carriers, where the sub-carrier spacing may be 15/30 kHz for below 6 GHz and 120/240 kHz for above 6 GHz. As shown in FIG. 3, the NR-PSS and the NR-SSS may be transmitted over 127 subcarriers in symbols l₀ and l₀+2, respectively. NR-PBCH may be transmitted over 12*20 subcarriers in symbols l₀ and l₀+3, and over 12*4 subcarriers in symbol l₀+2.

For low frequencies, it is expected that each cell may transmit one SSB that may cover the whole cell, while for higher frequencies, several beamformed SSB are expected to be needed to attain coverage over the whole cell, as illustrated in FIG. 4. The maximum number of configurable SSBs per cell may depend on the carrier frequency: below 3 GHz=4, 3-6 GHz=8 above 6 GHz=64. The SSBs may be transmitted in an SSB transmission burst which may last up to 5 ms. The periodicity of the SSB burst may be configurable with the following options: 5, 10, 20, 40, 80, 160 ms.

Channel State Information (CSI) framework in NR In NR, a UE may be configured with one or multiple CSI report configurations. Each CSI report configuration, defined by a higher layer information element (IE) CSI-ReportConfig, may be associated with a BandWidth Part (BWP) and may contain one or more of: a) a CSI resource configuration for channel measurement, b) CSI-Interference Measurement (IM) resource configuration for interference measurement, c) a Non-Zero Power (NZP) CSI-Reference Signal (RS) resource for interference measurement, d) reporting type, that is, aperiodic CSI, on PUSCH, periodic CSI, on physical uplink control channel (PUCCH), or semi-persistent CSI, on PUCCH, and DCI activated on PUSCH, e) report quantity specifying what to be reported, such as Rank Indicator (RI), Precoding Matrix Indicator (PMI), Channel Quality Indicator (CQI), f) codebook configuration such as type I or type II CSI and g) frequency domain configuration, that is, subband vs. wideband CQI or PMI, and subband size.

The CSI-ReportConfig IE is shown below according to the NR Radio Resource Control (RRC) specification 3GPP TS 38.331. Some parameters are omitted.

### CSI-ReportConfig Information Element

TABLE 1
An example of CSI-ReportConfig IE.

| CSI-ReportConfig ::= | SEQUENCE { | | |
|---|---|---|---|
| reportConfigId | | CSI-ReportConfigId, | |
| carrier | | ServCellIndex | OPTIONAL, -- Need S |

| resourcesForChannelMeasurement | CSI-ResourceConfigId, | |
|---|---|---|
| csi-IM-ResourcesForInterference | CSI-ResourceConfigId | OPTIONAL, -- Need R |
| nzp-CSI-RS-ResourcesForInterference | CSI-ResourceConfigId | OPTIONAL, -- Need R |
| reportConfigType | CHOICE { | |
| periodic | SEQUENCE { | |
| reportSlotConfig | CSI-ReportPeriodicityAndOffset, | |
| pucch-CSI-ResourceList | SEQUENCE (SIZE (1..maxNrofBWPs) ) OF PUCCH- | |
| CSI-Resource | | |
| }, | | |
| semiPersistentOnPUCCH | SEQUENCE { | |
| reportSlotConfig | CSI-ReportPeriodicityAndOffset, | |
| pucch-CSI-ResourceList | SEQUENCE (SIZE (1..maxNrofBWPs) ) OF PUCCH- | |
| CSI-Resource | | |
| }, | | |
| semiPersistentOnPUSCH | SEQUENCE { | |
| reportSlotConfig | ENUMERATED {s15, s110, s120, s140, s180, | |
| s1160, s1320}, | | |
| reportSlotOffsetList | SEQUENCE (SIZE (1.. maxNrofUL-Allocations) ) OF | |
| INTEGER (0..32), | | |
| p0alpha | P0-PUSCH-AlphaSetId | |
| }, | SEQUENCE { | |
| aperiodic | | |
| reportSlotOffsetList | SEQUENCE (SIZE (1..maxNrofUL-Allocations) ) OF | |
| INTEGER (0..32) | | |
| } | | |
| }, | | |
| reportQuantity | CHOICE { | |
| none | NULL, | |
| cri-RI-PMI-CQI | NULL, | |
| cri-RI-il | NULL, | |
| cri-RI-il-CQI | SEQUENCE { | |
| pdsch-BundleSizeForCSI | ENUMERATED {n2, n4} | OPTIONAL -- Need S |

| | |
|---|---|
| }, | |
| cri-RI-CQI | NULL, |
| cri-RSRP | NULL, |
| ssb-Index-RSRP | NULL, |
| cri-RI-LI-PMI-CQI | NULL |
| }, | SEQUENCE { |
| reportFreqConfiguration | |
| cqi-FormatIndicator | ENUMERATED { widebandCQI, subbandCQI } |
| OPTIONAL, -- Need R | |
| pmi-FormatIndicator | ENUMERATED { widebandPMI, subbandPMI } |
| OPTIONAL, -- Need R | |
| } | |
| -- Other parameters are ommited-- | |

A UE may be configured with one or multiple CSI resource configurations, each with a CSI-ResourceConfigId, for channel and interference measurement. Each CSI resource configuration for channel measurement or for NZP Channel State Information Reference Signal (CSI-RS) based interference measurement may contain one or more NZP CSI-RS resource sets. For each NZP CSI-RS resource set, it may further contain one or more NZP CSI-RS resources. A NZP CSI-RS resource may be periodic, semi-persistent, or aperiodic.

Similarly, each CSI-IM resource configuration for interference measurement may contain one or more CSI-IM resource sets. For each CSI-IM resource set, it may further contain one or more CSI-IM resources. A CSI-IM resource may be periodic, semi-persistent, or aperiodic.

Periodic CSI may start after it has been configured by RRC and may be reported on PUCCH, and the associated NZP CSI-RS resource(s) and CSI-IM resource(s) may also be periodic.

For semi-persistent CSI, it may be either on PUCCH or PUSCH. Semi-persistent CSI on PUCCH may be activated or deactivated by a Medium Access Control (MAC) Control Element (CE) command. Semi-persistent CSI on PUSCH may be activated or deactivated by DCI. For semi-persistent CSI, the associated NZP CSI-RS resource(s) and CSI-IM resource(s) may be either periodic or semi-persistent.

For aperiodic CSI, it may be reported on PUSCH and may be triggered by a CSI request bit field in DCI. For aperiodic CSI, the associated NZP CSI-RS resource(s) and CSI-IM resource(s) may be either periodic, semi-persistent, or aperiodic. The linkage between a code point of the CSI request field and a CSI report configuration may be via an aperiodic CSI trigger state. A UE may be configured by higher layer signaling a list of aperiodic CSI trigger states, where each of the trigger states may contain an associated CSI report configuration. The CSI request field may be used to indicate one of the aperiodic CSI trigger states and thus, one CSI report configuration.

Non-Coherent Joint Transmission (NC-JT) Over Multiple TRPs

In NR Rel-15, only PDSCH transmission from a single Transmission and Reception Point (TRP) is supported, in which case a UE may receive PDSCH from a single Transmission Points (TRP) at any time.

In NR Rel-16, PDSCH transmission over multiple Transmission Points (TRPs) was introduced. One of the multi-TRP schemes is NC-JT. NC-JT may be understood to refer to PDSCH data transmission to a UE over multiple TRPs with different Multiple-Input Multiple-Output (MIMO) layers transmitted from different TRPs.

Two flavors of NC-JT may be supported in NR Rel-16, that is, single DCI based NC-JT and multi-DCI based NC-JT. In single DCI based NC-JT, it may be assumed that a single scheduler may be used to schedule data transmission over multiple TRPs.

In multi-DCI (m-DCI) based NC-JT, independent schedulers may be used in different TRPs to schedule PDSCHs to a UE. Only semi-static coordination between TRPs may be possible. Semi-static coordination may be understood as exchange of configuration information that may not change frequently between TRPs, in order to schedule PDSCHs to a UE using m-DCI based NC-JT. In this case, the PDSCHs from different TRPs may be fully overlapping, partially overlapping or non-overlapping in time and/or frequency. An example is shown in FIG. 5, where PDSCHs are scheduled to a UE from two TRPs, TRP1 and TRP2, independently. As depicted in the top panel, TRP1 transmits a first DCI “DC1” and a first PDSCH “PDSCH1”, whereas TRP2 transmits a second DCI “DC2” and a second PDSCH “PDSCH2”. The DCI and PDSCH transmissions from TRP1 and TRP2 may be, as depicted in the bottom panel, fully overlapping in time, non-overlapping, as shown for a third DCI “DC13” scheduling a third PDSCH “PDSCH3”, and a fourth DCI “DC14” scheduling a fourth PDSCH “PDSCH4”, or partially overlapping in time, as shown for a fifth DCI “DCI5” scheduling a fifth PDSCH5 “PDSCH5” and a sixth DCI “DCI6” scheduling a sixth PDSCH “PDSCH6”. Note that while transmission of DCI5 and DCI6 are fully overlapping, transmission of PDSCH5 and PDSCH6 are only partially overlapping in time.

For multi-DCI operation, a UE may need to be configured with two CORESET pools, each associated with a TRP. Each CORESET pool may be understood as a collection of CORESETs that belongs to the same pool. A CORESET pool index may be configured in each CORESET with a value of 0 or 1. For the two DCIs in the above example, they may be transmitted in two CORESETs belonging to different CORESET pools, that is, with CORESETPoolIndex 0 and 1 respectively.

To make sure that a channel associated with each TRP may still be estimated in case of fully or partially overlapping PDSCHs, orthogonal DeModulation Reference Signal (DMRS) resources may need to be used in different TRPs.

Quasi Co-Location (QCL)

Since the TRPs may be in different physical locations, the propagation channels to the UE may also be different. Different antenna transmit beams may be used in the TRPs and so may be different receive beams at the UE. To facilitate receiving PDSCH data from different TRPs or different beams within the same or different TRPs, transmission configuration indicator (TCI) states were introduced in NR Rel-15.

A TCI state may contain Quasi Co-location (QCL) information between DMRS for PDSCH, and one or two DL reference signals such as CSI-RS or SSB. The supported QCL information types in NR may be: ‘QCL-TypeA’: {Doppler shift, Doppler spread, average delay, delay spread}, ‘QCL-TypeB’: {Doppler shift, Doppler spread}, ‘QCL-TypeC’: {Doppler shift, average delay} and ‘QCL-TypeD’: {Spatial Rx parameter}.

The QCL information may be used by a UE to apply one or more channel properties estimated from and associated with the DL reference signals, e.g., CSI-RS or SSB, to the DMRS based channel estimation for the PDSCH reception. For example, the channel may be first estimated based on CSI-RS, and the channel delay spread and Doppler shift parameters may be estimated from the source RS, that is, the CSI-RS in this case. Typically, the source Reference Signal (RS) indicated by the TCI state may be a periodic RS that the UE may continuously track the channel on and perform channel analysis. This information may then be subsequently used for determining channel filtering parameters during PDSCH reception based on DMRS.

Beam Management

At mmW frequencies, concepts for handling mobility between beams, both within and between TRPs, have been specified in NR. At these frequencies, where high-gain beamforming may be used, each beam may only be optimal within a small area, and the link budget outside the optimal beam may deteriorate quickly. Hence, frequent and fast beam switching may be needed to maintain high performance. To support such beam switching, a beam indication framework has been specified in NR. For example, for downlink data transmission, e.g., PDSCH, the downlink control information (DCI) may contain a transmission configuration indicator (TCI) field that may inform the UE about which beam is used so that it may adjust its receive beam accordingly. This may be understood to be beneficial for the case of analog Rx beamforming, where the UE may need to determine and apply the Rx beamforming weights before it may receive the PDSCH.

In what follows, the terminology “spatial filtering weights” or “spatial filtering configuration,” is adopted to refer to the antenna weights that may be applied at either the transmitter, e.g., gNB or UE, and the receiver, e.g., UE or gNB, for data/control transmission/reception. This term is more general in the sense that different propagation environments may lead to different spatial filtering weights that may match the transmission/reception of a signal to the channel. The spatial filtering weights may not always result in a beam in a strict sense.

Prior to data transmission, a training phase may be required in order to determine the gNB and UE spatial filtering configurations. This is illustrated in FIG. 6 and is referred to in NR as DL beam management. In NR, two types of reference signals (RSs) may be used for DL beam management operations, the channel state information RS (CSI-RS) and the synchronization signal/physical broadcast control channel (SS/PBCH) block, or SSB for short. FIG. 6 shows an example where CSI-RS is used to find an appropriate beam pair link (BPL), meaning a suitable gNB transmit spatial filtering configuration, e.g., gNB transmit (Tx) beam, plus a suitable UE receive spatial filtering configuration, e.g., UE Rx beam, resulting in sufficiently good link budget. Depicted in FIG. 6 is a beam training phase followed by a data transmission phase. For downlink data/control transmission, the gNB may indicate to the UE that the PDCCH/PDSCH DMRS is spatially quasi-co-located (QCL) with RS6, that is, the RS on which the UE may perform measurements during the UE beam sweep in the beam training phase. At least for uplink control channel transmission, the gNB may indicate to the UE that RS6 is the spatial relation for PUCCH. Spatial relation in this context may be understood as follows. If the UE uses a particular UE Rx beam to receive reference signal RS6 during the beam training phase, then, when the UE is indicated that RS6 is the spatial relation for PUCCH, then it may be understood to mean that PUCCH may have to be transmitted using the same beam, but in the opposite direction, as the beam used to receive RS6.

The beam training phase may consist of two sub-phases: a gNB beam sweep phase and a UE Beam sweep phase. In the above example in the gNB Tx beam sweep, depicted in the top panel of FIG. 6, the gNB may configure the UE to measure on a set of 5 CSI-RS resources, e.g., RS1 . . . RS5, which may be transmitted with 5 different spatial filtering configurations, that is, Tx beams. The UE may perform measurements on RS1-RS5. The UE may use a wide UE Rx beam during this first sub-phase, which is represented in FIG. 6 with a white circle. The UE may also be configured to report back the RS Identifier (ID) and the reference-signal receive power (RSRP) of the CSI-RS corresponding to the maximum measured RSRP. In this example, the maximum measured RSRP corresponds to RS4. In this way the gNB may learn what may be the preferred Tx beam from the UE perspective. In the subsequent UE Rx beam sweep, the gNB may transmit a number of CSI-RS resources in different OFDM symbols, all with the same spatial filtering configuration, e.g., Tx beam, as was used to transmit RS4 previously. The UE may then test a different Rx spatial filtering configuration, e.g., Rx beam, in each OFDM symbol in order to maximize the received RSRP. That is, the UE may perform a finer granularity UE Rx beam sweep to identify a narrower UE Rx beam for a given gNB Tx beam. The UE may remember the RS ID, RS ID 6 in this example, and the corresponding spatial filtering configuration that may result in the largest RSRP. The network may then refer to this RS ID in the future when DL data may be scheduled to the UE, thus allowing the UE to adjust its Rx spatial filtering configuration, Rx beam, to receive the PDSCH. As mentioned above, the RS ID may be contained in a transmission configuration indicator (TCI) that may be carried in a field in the DCI that may schedule the PDSCH. During the data transmission phase, the UE Tx beam used to transmit PUCCH/PUSCH is depicted with a solid black circle. It may be noted that in the example of FIG. 6, the gNB would transmit RS4 and RS6 with the same Tx beam. The reason different RS numbers RS4 and RS6 are used is that the gNB Tx sweep and UE Rx sweep may be typically configured in different CSI reporting configurations, that is, one Reporting configuration for gNB beam sweep where the UE may report a measurement of RS4; and another reporting configuration where the UE may perform a Rx beam sweep. The Reference signals in the two reporting configurations may be configured separately, hence different RS IDs may be used.

Maximum Permissible Exposure (MPE)

In 3GPP, two methods have been introduced to enable the UE to comply with regulatory exposure limits; reduced maximum output power, referred to as P-MPR, and reduced Uplink (UL) transmission duty cycle.

For Frequency Range 2 (FR2), maxUplinkDutyCycle-FR2 may be understood as a UE capability and may indicate the maximum percentage of symbols during 1 s that may be scheduled for uplink transmission regulatory exposure limits.

In case the field of UE capability maxUplinkDutyCycle-FR2 is not present or is present but the percentage of uplink symbols transmitted within any 1 s evaluation period is larger than maxUplinkDutyCycle-FR2, the UE may apply P-MPR to meet the regulatory exposure limits. By applying P-MPR the UE may reduce the maximum output power for a UE power class with x number of decibels (dB), where the range of x is still being discussed in 3GPP. For example, for UE power class 2 with a P-MPR value x=10 dB, the UE may be allowed to reduce the maximum output power (Pcmax) from 23 dBm to 13 dBm, that is, 23 dBm−10 dB=13 dBm. Due to P-MPR and maxUplinkDutyCycle-FR2, the maximum uplink performance of a selected UL transmission path may be significantly deteriorated.

Since the MPE issue may be highly directional in FR2, the required P-MPR and maxUplinkDutyCycle may be uplink beam specific and may very likely be different among different candidate uplink beams across different UE panels. That may be understood to mean that certain beams/panels, that is, the ones that may be pointing towards human body, may have potentially very high required P-MPR/low duty cycle while some other beams/panels, that is, the ones of which beam pattern may not coincide human body, may have very low required P-MPR/high duty cycle.

UE Antenna Architecture at mmWave Frequencies

For UEs, the signals may arrive and emanate from all different directions, hence it may be understood to be beneficial to have an antenna implementation at the UE which may have the possibility to generate omni-directional-like coverage in addition to the high gain narrow beams used at mmWave frequencies to compensate for the poor propagation conditions. One way to increase the omni-directional coverage at a UE may be to install multiple panels pointing in different directions as schematically illustrated in FIG. 7.

In order to reduce the complexity and heat generation at UEs at mmWave frequencies, it is expected that two TX/RX chains will be implemented per UE at mmWave frequencies, and that these two TX/RX chains may be switched between the multiple UE panels depending on which UE panel that currently may be best, as illustrated in FIG. 7. FIG. 7 is a schematic diagram illustrating a UE with multiple panels pointing in different directions to attain omni like coverage at mmWave frequencies. In FIG. 7, each panel is represented by a rectangle comprising bold crosses. Two TX/RX chains, each represented with a line ending in a circle, are switched between the three panels.

Since MPE issues may occur for certain UE beams/UE panels, causing the UE to reduce the maximum output power for that UE beam/panel, the optimal beam pair link for DL and UL might differ. For example, a first beam pair link associated with a first UE panel may be best for DL due to highest received power, however, due to MPE issues with that first UE panel, the optimal beam pair link for UL may be associated with a second UE panel that does not suffer from MPE issues. Therefore, it may be optimal for a UE, with respect to both DL and UL performance, to connect the TX chains to one panel and the RX chains to another panel, as schematically illustrated in FIG. 8. FIG. 8 is a schematic diagram illustrating that two TX/RX chains are switched between the three panels, where the two TX chains and two RX chains are connected to different UE panels.

### Recent Agreements in 3GPP and Relation

In NR, when a UE is configured with higher layer parameter groupBasedBeamReporting set to ‘enabled’, the UE may report either two different CRIs or two different SSBRIs in a single reporting instance for each report setting. The two CSI-RS Resource Indicators (CRIs) or two SS/PBCH Resource Block Indicators (SSBRIs) may be chosen such that the corresponding CSI-RS and/or SSB resources may be be received simultaneously by the UE. Non-group based reporting may be understood as reporting comprising sending a separate, or individual, report to different nodes, e.g., to different TRPs, on respective reference signals which may be respectively received by the wireless device 130 from the different nodes in a same set of time resources, that is, simultaneously. In RAN1 #103e, the following was agreed regarding non-group based beam reporting (Option 3 below).

Agreement

Down-select at least one of the following options for beam measurement/reporting enhancement to facilitate inter-TRP beam pairing in RAN1 #104-e:

According to Option 1, in a CSI-report, the UE may report N>1 pair/groups and M>=1 beams per pair/group. Different beams in different pairs/groups may be received simultaneously. It was left for further study (FFS) whether M is equal or may be different across different pair/group.

According to Option 2, in a CSI-report, a UE may report N(N>=1) pairs/groups and M (M>1) beams per pair/group. Different beams within a pair/group may be received simultaneously.

According to Option 3, a UE may report M(M>=1) beams in N (N>1) CSI-reports corresponding to N report settings. Different beams in different CSI-reports may be received simultaneously. It was left FFS whether and/or how to introduce an association between different CSI-reports. It was also left FFS whether and/or how to differentiate reported measurements for beams that are received simultaneously vs. beams that are not received simultaneously. It was further left FFS whether and/or how to introduce an indication along with the CSI-reports to indicate whether the beams in different CSI-reports may be received simultaneously. It was also left FFS: a) value of N and M in each option, b) association between different beams in the above options and different TRP/UE panels, c) identify new use cases per option compared with R16, including backhaul, and d) whether different beams in different pairs/groups/reports may be received by same spatial filter per option.

The intention with Option 3 above may be understood to be to support beam reporting for a multi-DCI based Multi-TRP scenario. In Option 3 above, the beams to be reported in each of the N report settings may correspond to different TRPs in a multi-DCI based Multi-TRP scenario. That is, the beams in a report setting may be reported towards one of the TRPs. If a first beam report contains one or multiple beams, for instance, M₁>=1, and a second beam report also contains one or multiple beams, for instance, M₂>=1, then any one of the M1 beams from a first TRP may be simultaneously received with any one of the M2 beams from a second TRP.

Existing methods to support reporting of beams and/or reference signals may result in low throughput.

### SUMMARY

As part of the development of embodiments herein, one or more challenges with the existing technology will first be identified and discussed.

Non-group based beam reporting has been agreed as one option in rel-17 for enhancing mTRP (multi-TRP) DL transmission. However, the details on how to support non-group based beam reporting is an open issue that may be understood to need to be solved.

According to the foregoing, it is an object of embodiments herein to improve the handling of reports in a wireless communications network.

According to a first aspect of embodiments herein, the object is achieved by a method, performed by a wireless device. The method is for handling a first indication. The wireless device operates in a wireless communications network. The first node obtains, the first indication. The first indication indicates that non-group based reporting is to be applied to any setting comprising the first indication. The setting indicates how to report, to a respective node, information. The information is on one or more respective reference signals to be received from the respective node. The reference signals use one or more respective beams of the respective node. The respective node is comprised in a plurality of nodes comprising a first node and at least a second node. The first node then performs measurements on the one or more respective signals received from the respective node. The first node also sends, based on the first indication, a non-group based report to the first node. The report comprises measurements on one or more first respective reference signals received from the first node. Based on the same first indication, the first node further sends another non-group based report to the second node. The another non-group based report comprises measurements on the one or more second respective reference signals received from the second node.

According to a second aspect of embodiments herein, the object is achieved by a method, performed by the second node. The method is for handling the first indication. The first node sends the first indication to the wireless device. The wireless device operates in the wireless communications network. The first indication indicates that non-group based reporting is to be applied to any setting comprising the first indication. The setting indicates how to report, to the respective node the information on the one or more respective reference signals to be received from the respective node. The reference signals use the one or more respective beams of the respective node. The respective node is comprised in the plurality of nodes comprising the first node and at least the second node. The first node then receives, based on the first indication, the non-group based report from the wireless device. The report comprises the measurements on the one or more first respective reference signals transmitted by the first node. Based on the same first indication, the another non-group based report is sent to the second node by the wireless device. The another non-group based report comprises the measurements on the one or more second respective reference signals received by the wireless device from the second node.

According to a third aspect of embodiments herein, the object is achieved by the wireless device, for handling the first indication. The wireless device is configured to operate in the wireless communications network. The wireless device is further configured to obtain the first indication configured to indicate that non-group based reporting is to be applied to any setting comprising the first indication. The setting is configured to indicate how to report, to the respective node, the information. The information is configured to be on the one or more respective reference signals configured to be received from the respective node. The reference signals are configured to use the one or more respective beams of the respective node. The respective node is configured to be comprised in the plurality of nodes configured to comprise the first node and at least the second node. The wireless device is further configured to perform measurements on the one or more respective signals configured to be received from the respective nodes. The wireless device is also configured to send, based on the first indication, the non-group based report to the first node. The report is configured to comprise the measurements on the one or more first respective reference signals configured to be received from the first node. The wireless device is also configured to, based on the same first indication, send the another non-group based report to the second node. The another non-group based report is configured to comprise the measurements on the one or more second respective reference signals configured to be received from the second node.

According to a fourth aspect of embodiments herein, the object is achieved by the first node, for handling the first indication. The first node is configured to operate in the wireless communications network. The first node is further configured to send the first indication to the wireless device. The wireless device is configured to operate in the wireless communications network. The first indication is configured to indicate that non-group based reporting is to be applied to any setting comprising the first indication. The setting is configured to indicate how to report, to the respective node, the information. The information is configured to be on the one or more respective reference signals configured to be received from the respective node. The reference signals are configured to use the one or more respective beams, of the respective node. The respective node is configured to be comprised in the plurality of nodes configured to comprise the first node and at least the second node. The first node is also configured to receive, based on the first indication, the non-group based report from the wireless device. The report is configured to comprise the measurements on the one or more first respective reference signals configured to be transmitted by the first node. Based on the same first indication, the another non-group based report is configured to be sent to the second node by the wireless device. The another non-group based report is configured to comprise the measurements on the one or more second respective reference signals configured to be received by the wireless device from the second node.

By obtaining the first indication, the wireless device is able to perform the measurements accordingly and then send, based on the first indication, the non-group based report to the first node and the another non-group based report to the second node, each based on the respective reference signals received from the respective node. Embodiments herein may thereby be understood to enable beam reporting to support mTRP operation with non-ideal backhaul between the TRPs, e.g., a multi-DCI based multi-TRP scenario. Particularly, the embodiments herein may enable beam reports to be received at the plurality of nodes directly from the UE which may be understood to reduce the latency compared to if the beam reports for one of the plurality of nodes have to be conveyed through the another node, e.g., the report to the second node had to be covered through the first node, which would be required for group-based beam reporting. This may be understood to mean that the beam for a respective node of the plurality of nodes may be applied with short aging of the channel to the wireless device, which may be understood to improve the average link budget between the respective node and the wireless device, which may in turn increase the performance and reduce the risk of radio link failure and dropped connections.

### BRIEF DESCRIPTION OF THE DRAWINGS

Examples of embodiments herein are described in more detail with reference to the accompanying drawings, according to the following description.

FIG. 1 is a schematic block diagram illustrating an example of an NR time-domain structure with 15 kHz subcarrier spacing.

FIG. 2 is a schematic block diagram illustrating an example of an NR physical resource grid.

FIG. 3 is a schematic block diagram illustrating an example of a structure of an SSB.

FIG. 4 is a schematic block diagram illustrating an example of a single SSB covering a cell (left) and multiple beamformed SSBs that together cover the cell (right).

FIG. 5 is a schematic block diagram illustrating an example of m-DCI based NC-JT transmission from multiple TRPs.

FIG. 6 is a schematic block diagram illustrating a beam training phase followed by data transmission phase.

FIG. 7 is a schematic block diagram illustrating a UE with multiple panels pointing in different directions.

FIG. 8 is a schematic block diagram illustrating a UE with multiple panels and TX/RX chains.

FIG. 9 is a schematic diagram illustrating an example of a wireless communications network, according to embodiments herein.

FIG. 10 is a flowchart depicting a method in a wireless device, according to embodiments herein.

FIG. 11 is a schematic block diagram illustrating an example of aspects of methods according to embodiments herein.

FIG. 12 is a schematic block diagram illustrating another example of aspects of methods according to embodiments herein.

FIG. 13 is a schematic block diagram illustrating a further example of aspects of methods according to embodiments herein.

FIG. 14 is a schematic block diagram illustrating an additional example of aspects of methods according to embodiments herein.

FIG. 15 is a flowchart depicting a method in a network node, according to embodiments herein.

FIG. 16 is a schematic block diagram illustrating embodiments of a wireless device, according to embodiments herein.

FIG. 17 is a schematic block diagram illustrating embodiments of a network node, according to embodiments herein.

FIG. 18 is a flowchart depicting a method in a wireless device, according to examples related to embodiments herein.

FIG. 19 is a flowchart depicting a method in a network node, according to examples related to embodiments herein.

FIG. 20 is a schematic block diagram illustrating a telecommunication network connected via an intermediate network to a host computer, according to embodiments herein.

FIG. 21 is a generalized block diagram of a host computer communicating via a base station with a user equipment over a partially wireless connection, according to embodiments herein.

FIG. 22 is a flowchart depicting embodiments of a method in a communications system including a host computer, a base station and a user equipment, according to embodiments herein.

FIG. 23 is a flowchart depicting embodiments of a method in a communications system including a host computer, a base station and a user equipment, according to embodiments herein.

FIG. 24 is a flowchart depicting embodiments of a method in a communications system including a host computer, a base station and a user equipment, according to embodiments herein.

FIG. 25 is a flowchart depicting embodiments of a method in a communications system including a host computer, a base station and a user equipment, according to embodiments herein.

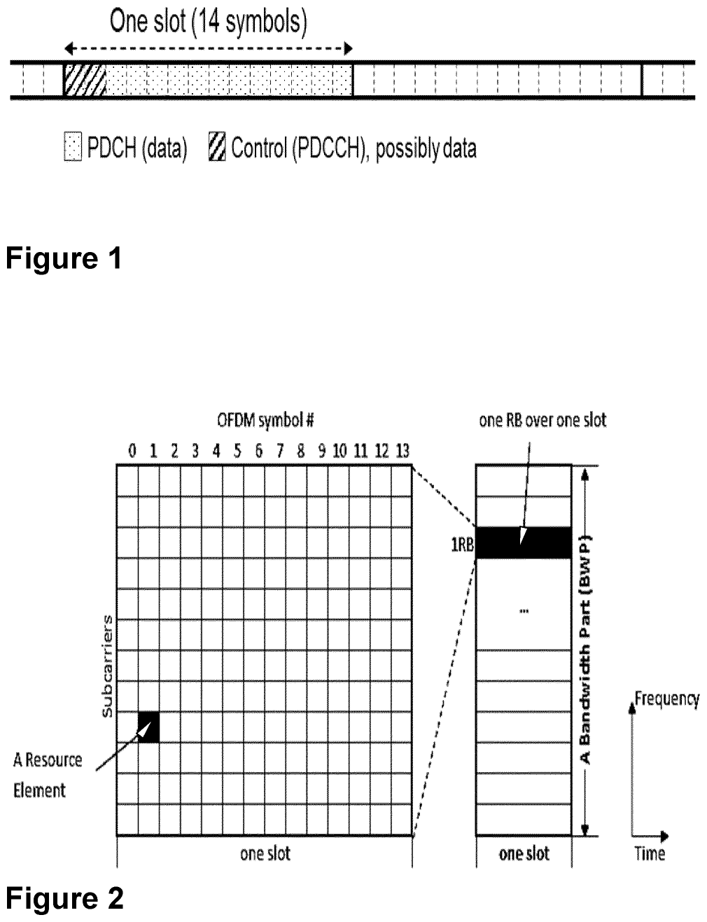

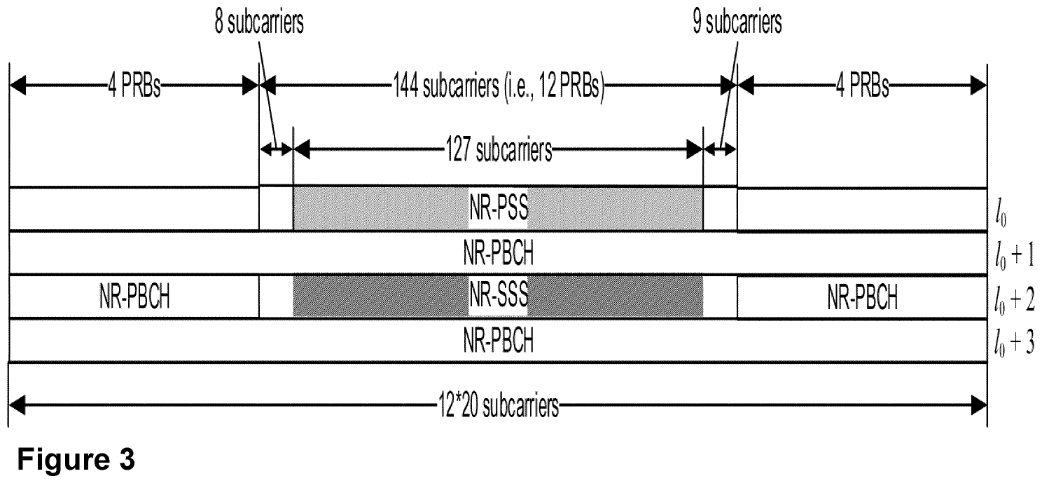

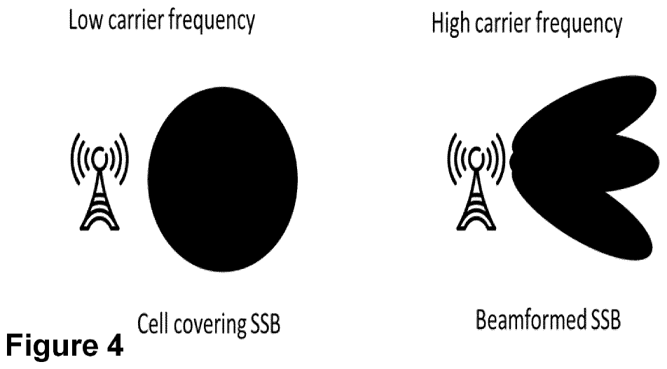

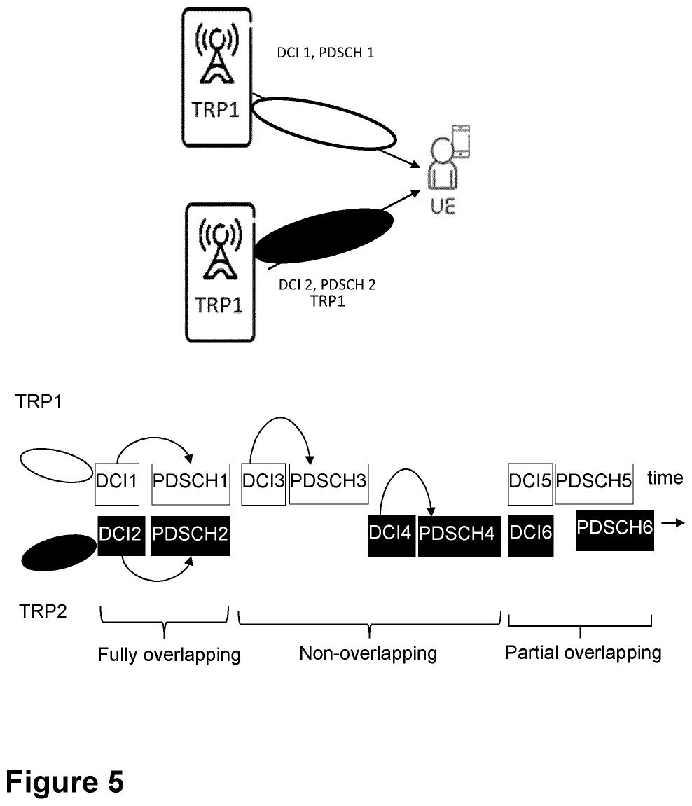

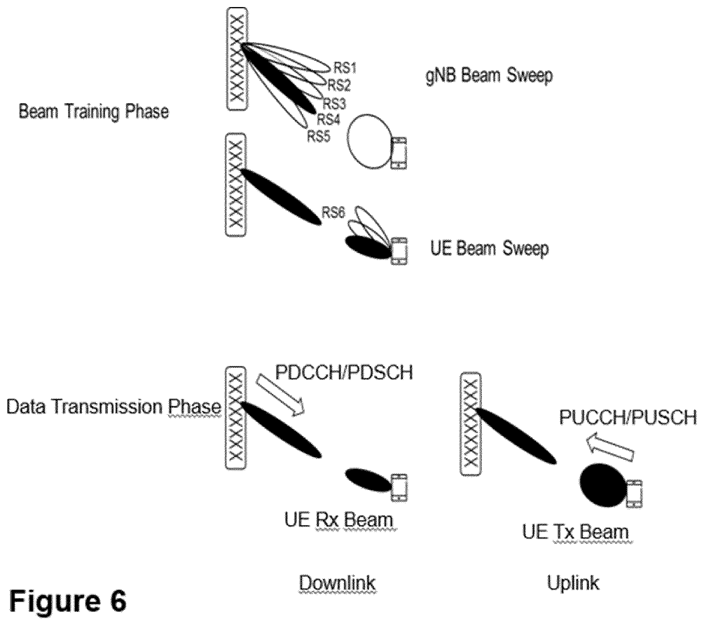

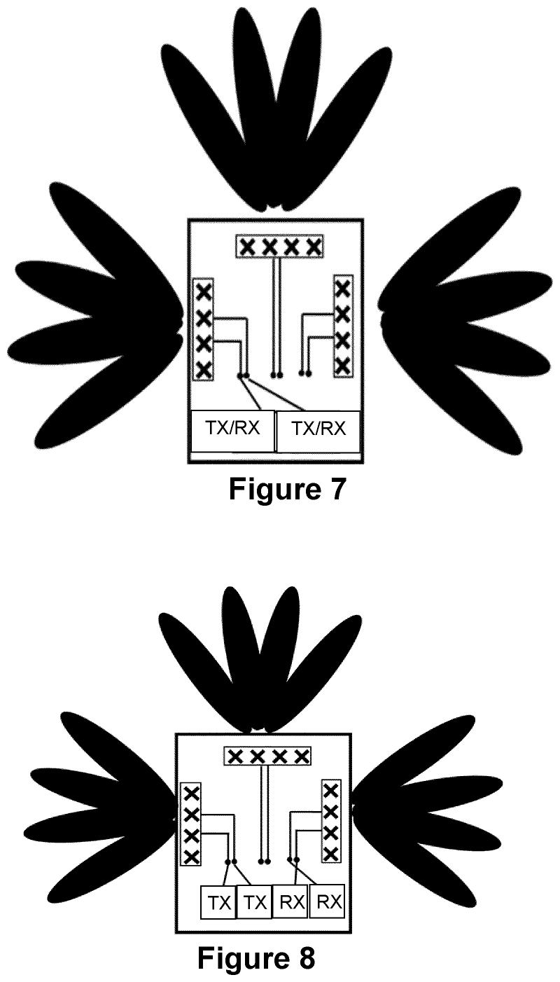

### DETAILED DESCRIPTION

Certain aspects of the present disclosure and their embodiments may provide solutions to the challenges described in the Summary section or other challenges. Embodiments herein may be generally understood to relate to enhancements on non-group based beam reporting for multi-TRP (mTRP). Embodiments herein may relate to a framework to enable non group-based beam reporting for mTRP scenarios.

Some of the embodiments contemplated will now be described more fully hereinafter with reference to the accompanying drawings, in which examples are shown. In this section, the embodiments herein will be illustrated in more detail by a number of exemplary embodiments. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art. It should be noted that the exemplary embodiments herein are not mutually exclusive. Components from one embodiment may be tacitly assumed to be present in another embodiment and it will be obvious to a person skilled in the art how those components may be used in the other exemplary embodiments.

Note that although terminology from LTE/5G has been used in this disclosure to exemplify the embodiments herein, this should not be seen as limiting the scope of the embodiments herein to only the aforementioned system. Other wireless systems with similar features, may also benefit from exploiting the ideas covered within this disclosure.

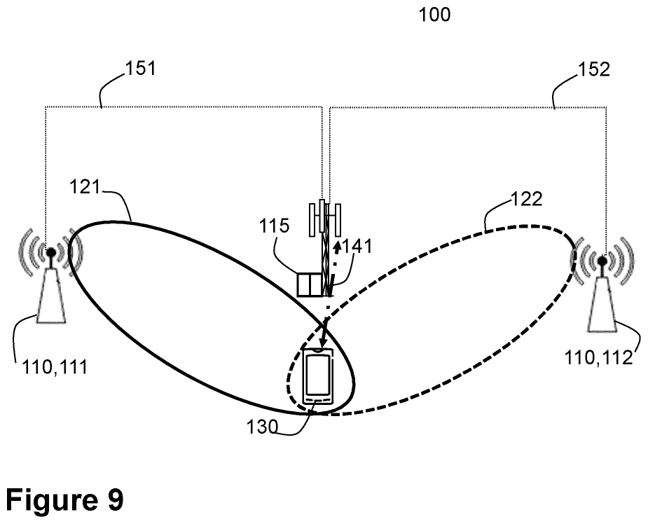

FIG. 9 depicts a non-limiting example of a wireless network or wireless communications network 100, sometimes also referred to as a wireless communications system, cellular radio system, or cellular network, in which embodiments herein may be implemented. The wireless communications network 100 may typically be a 5G system, 5G network, or Next Gen System or network, NR-U, LAA, or MulteFire. The wireless communications network 100 may alternatively be a younger system than a 5G system. The wireless communications network 100 may also support other technologies such as, for example, Long-Term Evolution (LTE), LTE-Advanced/LTE-Advanced Pro, e.g., LTE Frequency Division Duplex (FDD), LTE Time Division Duplex (TDD), LTE Half-Duplex Frequency Division Duplex (HD-FDD), LTE operating in an unlicensed band, Wideband Code Division Multiple Access (WCDMA), Universal Terrestrial Radio Access (UTRA) TDD, Global System for Mobile telecommunications (GSM) network, GSM/Enhanced Data Rate for GSM Evolution (EDGE) Radio Access Network (GERAN) network, Ultra-Mobile Broadband (UMB), EDGE network, network comprising of any combination of Radio Access Technologies (RATs) such as e.g. Multi-Standard Radio (MSR) base stations, multi-RAT base stations etc., any 3rd Generation Partnership Project (3GPP) cellular network, WiFi networks, Worldwide Interoperability for Microwave Access (WiMax), Internet of Things (IoT), NarrowBand Internet of Things (NB-IoT), or any cellular network or system. Thus, although terminology from 5G/NR and LTE may be used in this disclosure to exemplify embodiments herein, this should not be seen as limiting the scope of the embodiments herein to only the aforementioned system.

The wireless communications network 100 comprises as a plurality, or set, of nodes 110. The set of nodes 110 comprises a first node 111, and at least a second node 112. The first node 111 and one second node 112 are depicted in the non-limiting example of FIG. 9. The wireless communications network 100 may comprise other nodes.

Any of the first node 111 and the second node 112 may be a network node. That is, a transmission point such as a radio base station, or any other network node with similar features capable of serving a user equipment, such as a wireless device or a machine type communication device, in the wireless communications network 100. In particular embodiments, any of the first node 111 and the second node 112 may be a Transmission/Reception Point (TRP), as e.g., described in 3GPP TS 38.300. In some examples, a TRP may be either a node or a radio head. A TRP may be represented by, or indicated by, a spatial relation or a Transmission Configuration Indication (TCI) state. In some examples, a TRP may be using multiple TCI states. In some embodiments, a TRP may be a part of a network node, e.g., a gNB, transmitting and receiving radio signals to/from a UE such as the wireless device 130 described below, according to physical layer properties and parameters inherent to that element. In some embodiments, in Multiple Transmit/Receive Point multi-TRP operation, a serving cell can schedule a UE from two TRPs, providing better PDSCH coverage, reliability and/or data rates. There may be two different operation modes for multi-TRP: single-DCI and multi-DCI. For both modes, control of uplink and downlink operation may be done by both physical layer and MAC. In single-DCI mode, a UE may be scheduled by the same DCI for both TRPs and in multi-DCI mode, a UE may be scheduled by independent DCIs from each TRP.

Any of the first node 111 and the second node 112 may be, or may be comprised in or managed by, a network node 115. In some examples, the first node 111 may be comprised in or managed by a first network node, e.g., a first gNB, and the second node 112 may be comprised in or managed by, a second network node, e.g., a second gNB. In the non-limiting example of FIG. 9, the first node 111 and the second node 112 are managed by the same network node 115, but this may be understood to be non-limiting. The network node 115 may be a radio network node, such as a radio base station, for example a gNB, an eNB, or any other network node with similar features capable of serving a wireless device, such as the wireless device 130 described below, in the wireless communications network 100. In other examples, which are not depicted in FIG. 9, the network node 115 may be a distributed node, such as a virtual node in the cloud, and may perform its functions entirely on the cloud, or partially, in collaboration with a radio network node. Any of the first node 111 and the second node 112 may be a distributed node, and may perform its functions partially on the cloud, in collaboration with a radio network node. The network node 115 may be of different classes, such as, e.g., macro node, home node, or pico base station, based on transmission power and thereby also cell size. In some examples, the network node 115 may serve receiving nodes with serving beams. The radio network node may support one or several communication technologies, and its name may depend on the technology and terminology used. The network node 115 may be directly connected to one or more core networks.

The wireless communications network 100 may cover a geographical area, which in some embodiments may be divided into cell areas, wherein each cell area may be served by a radio network node, although, one radio network node may serve one or several cells.

Any of the first node 111 and the second node 112 may manage a respective beam 121, 122. In the example of FIG. 9, the first node 111 manages a first beam 121 and the second node 112 manages a second beam 122. It may be understood that any of the first node 111 and the second node 112 may manage more respective beams.

A plurality of user equipments may be located in the wireless communication network 100, whereof a wireless device 130, is depicted in the non-limiting example of FIG. 9. The wireless device 130 comprised in the wireless communications network 100 may be a wireless communication device such as a 5G UE, or a UE, which may also be known as e.g., mobile terminal, wireless terminal and/or mobile station, a mobile telephone, cellular telephone, or laptop with wireless capability, just to mention some further examples. Any of the wireless devices comprised in the wireless communications network 100 may be, for example, portable, pocket-storable, hand-held, computer-comprised, or a vehicle-mounted mobile device, enabled to communicate voice and/or data, via the RAN, with another entity, such as a server, a laptop, a Personal Digital Assistant (PDA), or a tablet, Machine-to-Machine (M2M) device, device equipped with a wireless interface, such as a printer or a file storage device, modem, or any other radio network unit capable of communicating over a radio link in a communications system. The wireless device 130 comprised in the wireless communications network 100 may be enabled to communicate wirelessly in the wireless communications network 100. The communication may be performed e.g., via a RAN, and possibly the one or more core networks, which may be comprised within the wireless communications network 100.

The wireless device 130 may receive information on a respective reference signal from a respective node 111, 112, of the plurality of nodes 110, on a respective beam 121, 122. That is, the wireless device 130 may, for example, receive a first reference signal over the first beam 121 from the first node 111, and a second reference signal over the second beam 122 from the second node 112.

The wireless device 130 may be configured to communicate within the wireless communications network 100 with the first node 111 over the first beam 121. The wireless device 130 may be configured to communicate within the wireless communications network 100 with the second node 112 over the second beam 122. The wireless device 130 may be configured to communicate within the wireless communications network 100 with the network node 115 over a link 141, e.g., a radio link. The link 141 may be the same or different than any of the first beam 121 and the second beam 122.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

In general, the usage of “first”, “second”, “third”, “fourth”, “fifth”, “sixth”, “seventh”, “eighth”, “ninth” and/or “tenth” herein may be understood to be an arbitrary way to denote different elements or entities, and may be understood to not confer a cumulative or chronological character to the nouns they modify, unless otherwise noted, based on context.

Several embodiments are comprised herein. It should be noted that the examples herein are not mutually exclusive. Components from one embodiment may be tacitly assumed to be present in another embodiment and it will be obvious to a person skilled in the art how those components may be used in the other exemplary embodiments.

More specifically, the following are embodiments related to a wireless device, such as the wireless device 130, e.g., a UE, and embodiments related to a node, such as the first node 111, e.g., a TRP.

Some embodiments herein will now be further described with some non-limiting examples.

In the following description, any reference to a/the UE, or simply “UE” may be understood to equally refer the wireless device 130; any reference to a/the first node, and/or a/the “TRP”, “TRP1” “network”, may be understood to equally refer to the first node 111; any reference to a/the “TRP2”, “other TRP” may be understood to equally refer to the second node 112; any reference to the “gNB” may be understood to equally refer to the network node 110.

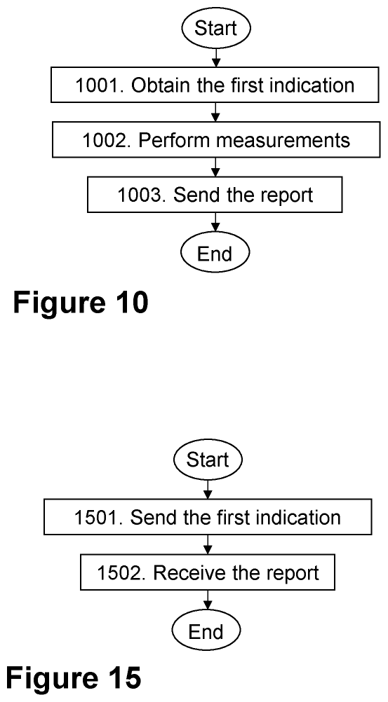

Embodiments of a method, performed by the wireless device 130, will now be described with reference to the flowchart depicted in FIG. 10. The method may be understood to be for handling a first indication. The wireless device 130 operates in the wireless communications network 100.

The method comprises the actions described below. One or more embodiments may be combined, where applicable. All possible combinations are not described to simplify the description. It should be noted that the examples herein are not mutually exclusive. Components from one example or embodiment may be tacitly assumed to be present in another example or embodiment and it will be obvious to a person skilled in the art how those components may be used in the other examples or embodiments.

Action 1001

In this Action 1001, the wireless device 130 obtains a first indication. The first indication indicates that non-group based reporting is to be applied to any setting comprising the first indication. That is, the first indication may indicate that non-group based reporting is to be applied to any setting comprising the same first indication.

A setting may be understood as a configuration. That is, the setting may be understood to be, or may be understood to be referred to as a “report setting” or “report configuration”. The report setting may be, for example, as described in 3GPP TS 38.331, version 16.3.1.

The setting indicates how to report, to the respective node 111, 112, information on one or more respective reference signals to be received from the respective node 111, 112. The reference signals use one or more respective beams 121, 122 of the respective node 111, 112. The respective node 111, 112 is comprised in the plurality of nodes 110 comprising the first node 111 and at least the second node 112.

The one or more reference signals may be e.g., a Channel State Information Reference signal, CSI-RS, a NZP CSI-RS or an SSB.

Obtaining in this Action 1001 may comprise receiving, e.g., from the first node 111, from the network node 115, or from another node operating in the wireless communications network 100, or retrieving from a memory storage, e.g., comprised in the wireless device 130.

The first indication may be received from the first node 111.

The obtaining in this Action 1001 may be performed, e.g., via the first beam 121, or the link 141.

Each of the respective nodes 111, 112, may be indicated by, or represented by, one of a: TRP, radio head, spatial relation, Transmission Configuration Indication state, Non-zero power Chanel State Information-Reference Signal resource set, Coresetpoolindex and an identifier.

It may be noted that the term TRP may not be captured in 3GPP specifications. A TRP may instead be represented by a TCI state, an NZP CSI-RS resource set, a CoresetpoolIndex or an identifier in 3GPP specifications.

The first indication may indicate an association between the respective reference signals on the respective beams 121, 122, and/or between report settings.

Each beam may correspond to a respective spatial filtering configuration of the respective node 111, 112.

In some embodiments, the first indication may be a new single parameter nonGroupBasedReportID, e.g., as described later.

The first indication may be comprised in a CSI report setting.

In some embodiments, the first indication may be comprised in a second indication.

The second indication may be an information element (IE) comprising at least an identifier (ID) indicating a non-group based report, and at least a third indication indicating which respective node 111, 112 the one or more respective reference signals are transmitted from.

Examples to indicate association between different CSI report settings and association between SSB/CSI-RS and different TRPs will now be described.

In a first example, the new single parameter “nonGroupBasedReportID” may be configured in a CSI report setting. It may be noted that the CSI report setting may be given by CSI-ReportConfig in 3GPP TS 38.331, version 16.3.1, as illustrated in Table 2. If the parameter is configured and there is another CSI report setting configured with the same “nonGroupBasedReportID”, the wireless device 130 may be required to assume that non-group based beam reporting may have to be applied for these two report settings. The wireless device 130 may be required to assume that the downlink reference signal (DL-RS) e.g., NZP CSI-RS or SSB, associated with each CSI report setting may come from different TRPs. This may be understood to mean that if three or more CSI report settings are configured with the same “nonGroupBasedReportID”, the wireless device 130 may be required to assume that the DL-RS associated to the respective CSI report setting is coming from a different TRP, and the wireless device 130 may have to make sure that all the reported beams for all the CSI report settings with the same “nonGroupBasedReportID” may be received simultaneously. It may be noted that only beams associated with different CSI report settings may have to be received simultaneously. The different beams within one CSI-report setting may not need to be received simultaneously. Hence, not all the beams in all CSI reports may have to be received simultaneously. For example, in case there may be one CSI report with beam1 and beam2, and a second CSI report with beam3 and beam4, then the wireless device 130 may have to make sure that beam3 may be received simultaneously as beam1 and beam2, and that beam 4 may be received simultaneously as beam1 and beam2. But the wireless device 130 may be understood to not need to receive beam1 and beam2 simultaneously, or beam3 and beam4 simultaneously.

TABLE 2

| | |
|---|---|
| ASN1START | |
| -- TAG-CSI-REPORTCONFIG-START | |
| CSI-ReportConfig ::= | SEQUENCE { |

| reportConfigId | CSI-ReportConfigId, | |
|---|---|---|
| carrier | ServCellIndex | OPTIONAL, -- Need S |
| resourcesForChannelMeasurement | CSI-ResourceConfigId, | |
| csi-IM-ResourcesForInterference | CSI-ResourceConfigId | OPTIONAL, -- Need R |
| nzp-CSI-RS-ResourcesForInterference | CSI-ResourceConfigId | OPTIONAL, -- Need R |

| | |
|---|---|
| reportConfigType | CHOICE { |
| periodic | SEQUENCE { |
| reportSlotConfig | CSI-ReportPeriodicityAndoffset, |
| pucch-CSI-ResourceList | SEQUENCE (SIZE (1..maxNrofBWPs) ) OF PUCCH-CSI- |
| Resource | |
| }, | |
| semiPersistentOnPUCCH | SEQUENCE { |
| reportSlotConfig | CSI-ReportPeriodicityAndOffset, |
| pucch-CSI-ResourceList | SEQUENCE (SIZE (1..maxNrofBWPs) ) OF PUCCH-CSI- |
| Resource | |
| }, | |
| semiPersistentOnPUSCH | SEQUENCE { |
| reportSlotConfig | ENUMERATED (s15, s110, s120, s140, s180, s1160, |
| s1320}, | |
| reportSlotOffsetList | SEQUENCE (SIZE (1.. maxNrofUL-Allocations) ) OF |
| INTEGER(0..32), | |
| p0alpha | p0-PUSCH-AlphaSetId |
| }, | |
| aperiodic | SEQUENCE { |
| reportSlotOffsetList | SEQUENCE (SIZE (1..maxNrofUL-Allocations)) OF |
| INTEGER (0..32) | |
| } | |
| }, | |

| | |
|---|---|
| nonGroupBasedReportID | INTEGER (0..N) |

In a second example, it may be assumed that the DL-RS may be explicitly associated to different TRPs, instead of an implicit association as was used in the first example where DL-RS belonging to different CSI report settings may be associated with different TRP. The explicit association between DL-RS and TRPs may for example be done by associating each DL-RS with a CORESET Pool index (CorsepoolIndex) or a TRP identifier.

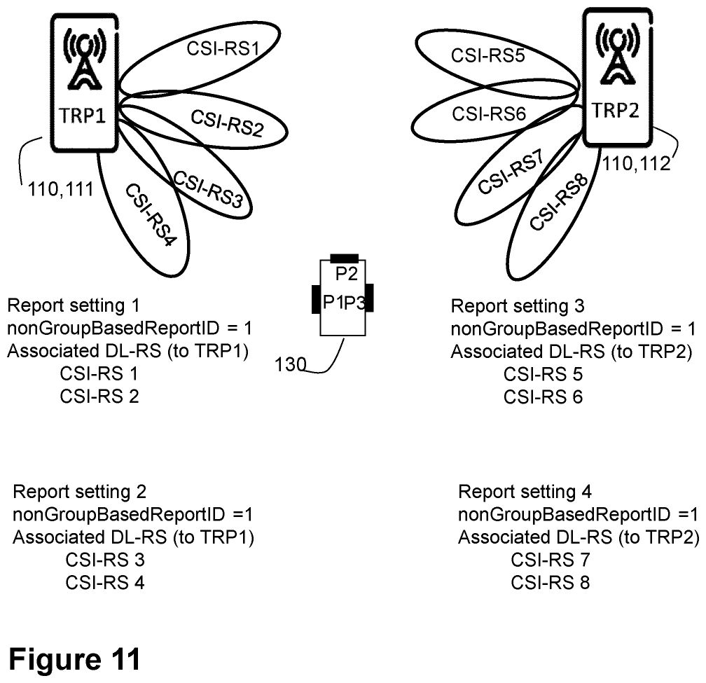

The wireless device 130 may then have to make sure that it may receive the DL-RS belonging to different TRPs simultaneously, for all DL-RS associated with all CSI report settings with the same “nonGroupBasedReportID”. One example of this is illustrated in FIG. 11, where the wireless device 130, a UE in this example, is configured with four CSI report settings with the same “nonGroupBasedReportID”: Report setting 1, Report setting 2, Report setting 3 and Report setting 4. In the non-limiting example depicted in this Figure, it is assumed that the CSI-RSs 1 to 4 are associated explicitly, e.g., by configuring each CSI-RS resource with a coresetPoolIndex or a TRP identifier, or implicitly, e.g., through the spatial QCL relation to an SSB, and where the SSBs are grouped according to TRPs, to the first node 111, in this example, TRP1, and that CSI-RS 5 to 8 are associated with the second node 112, in this example, TRP2. The associated DL-RSs, to TRP1, to Report setting 1 are CSI-RS 1 and CSI-RS 2. The associated DL-RSs, to TRP 1, to Report setting 2 are CSI-RS 3 and CSI-RS 4. The associated DL-RSs to Report setting 3, to TRP2, are CSI-RS 5 and CSI-RS 6. The associated DL-RSs to Report setting 4, to TRP2 are CSI-RS 7 and CSI-RS 8. The wireless device 130 may then have to make sure that the reported beams associated to any of the two CSI report setting 1 and CSI report setting 2 may be received simultaneously as the reported beam associated with any of the two CSI report setting 3 and CSI report setting 4. For example, if it is assumed that the wireless device 130 reports the best beam per CSI report setting, and that the wireless device 130 then reports CSI-RS 1 for CSI report setting 1, CSI-RS 3 for CSI report setting 2, CSI-RS 5 for CSI report setting 3 and CSI-RS 8 for CSI report setting 4, the wireless device 130 has to make sure that both of CSI-RS 1 and CSI-RS 3 may respectively be received simultaneously with CSI-RS 5 and CSI-RS 8. That is, CSI-RS1 may have to be simultaneously received with CSI-RS5 and CSI-RS3 may have to be simultaneously received with CSI-RSB. However, the wireless device 130 does not have to be able to receive CSI-RS 1 and CSI-RS 3 simultaneously or CSI-RS 5 and CSI-RS 8 simultaneously.

What is meant by simultaneous reception here may be understood to be that the wireless device 130 may be able to receive the two DL-RSs in the same time and/or frequency resources using different receive beams, where the different receive beams may be given by the spatial Rx parameters used to receive the QCL-TypeD source RSs in the different TCI states.

In the non-limiting example of FIG. 11, the wireless device 130 comprises three different panels: panel 1 (P1), panel 2 (P2) and panel 3 (P3).

In accordance with the foregoing, the first indication may indicate that the wireless device 130 is to ensure that the respective reference signals to be received, e.g., on the respective beams 121, 122 that is, the respective reference signals using the respective spatial filtering configurations, are enabled to be received in the same time resources, e.g., and/or frequency resources, e.g., simultaneously, from the respective nodes 111, 112, by the wireless device 130, e.g., in different beams such as the first beam 121 and the second beam 122.

In another example, a new “nonGroupBasedReportl E” may be configured per CSI report setting, which may contain information about the non-group based beam reporting. In accordance with this, the second indication may be a nonGroupBasedReportIE, e.g., as described later.

One example of this is illustrated in Table 3. The “nonGroupBasedReportIE” may, for example, contain one or more of the following parameters:
i) the first indication, e.g., “nonGroupBasedReportID”, as described above, the non-GroupBasedReportID may be used in linking different CSI report settings together;
ii) CoresetpoolIndex, indicating which TRP the DL-RS associated to that CSI report setting are transmitted from;
iii) Timing information, wherein the Timing information may be understood to be related to the non-group based reporting. For example, a maximum time that may indicate how old DL-RS may be at most while still being included, or considered, for the non-group based beam reporting. For instance, consider the case that timing information of T is configured as part of the nonGroupBasedReportIE, and the wireless device 130 is sending a non-group based report to a TRP x at time t. Then, in order for any DL-RS instance transmitted from TRP x to be considered for non-group based beam reporting, the DL-RS instance may be required to be between the time interval (t-T) and t. The timing information T may be configured in units of slots. In some cases, the DL-RS instance to be considered for non-group based beam reporting may be either the earliest or the latest DL-RS instance between the time interval (t-T) and t;
iv) In an alternative example, in order for any DL-RS instance transmitted from TRP x to be considered for non-group based beam reporting, the DL-RS instance may be required to be between the time interval (t-T) and t-T₀, where T₀ is a parameter related to computing/processing the non-group based beam report. In some examples, the parameter T₀ may be determined using a wireless device 130 capability that may be reported from the wireless device 130 to the network. In some cases, the DL-RS instance to be considered for non-group based beam reporting may be either the earliest or the latest DL-RS instance between the time interval (t-T) and t;
v) In some cases, if the wireless device 130 may be equipped with multiple antenna panels, where each panel may be associated with an antenna panel ID, then the antenna panel ID may be configured as part of the nonGroupBasedReportIE.

When the antenna panel ID is configured as part of nonGroupBasedReportl E and the information in nonGroupBasedReportIE is associated with a CSI report setting, the wireless device 130 may use the antenna panel associated with the antenna panel ID when measuring the DL-RS to be included in the non-group based report associated with the CSI report setting.
vi) In some cases, multiple antenna elements at the wireless device 130 may be grouped together and be associated with an antenna group ID. The UE may have multiple such antenna group IDs. In these cases, the antenna group ID may be configured as part of the nonGroupBasedReportIE. When the antenna group ID is configured as part of nonGroupBasedReportIE and the information in nonGroupBasedReportIE is associated with a CSI report setting, the wireless device 130 may use the antenna elements associated with the antenna group ID when measuring the DL-RS to be included in the non-group based report associated with the CSI report setting.
vii) Other information: such as, for example, how to report the beams, how many beams to report, what metric to report etc.

TABLE 3

ASN1START
-- TAG-CSI-REPORTCONFIG-START

| | |
|---|---|
| CSI-ReportConfig ::= | SEQUENCE { |

| reportConfigId | CSI-ReportConfigId, | |
|---|---|---|
| carrier | ServCellIndex | OPTIONAL, -- Need S |
| resourcesForChannelMeasurement | CSI-ResourceConfigId, | |
| csi-IM-ResourcesForInterference | CSI-ResourceConfigId | OPTIONAL, -- Need R |
| nzp-CSI-RS-ResourcesForInterference | CSI-ResourceConfigId | OPTIONAL, -- Need R |

| reportConfigType | | CHOICE { |
|---|---|---|
| periodic | | SEQUENCE { |
| reportSlotConfig | | CSI-ReportPeriodicityAndoffset, |
| pucch-CSI-ResourceList | | SEQUENCE (SIZE (1..maxNrofBWPs) ) OF PUCCH-CSI- |
| Resource | | |
| }, | | |
| semiPersistentOnPUCCH | | SEQUENCE { |
| reportSlotConfig | | CSI-ReportPeriodicityAndOffset, |
| pucch-CSI-ResourceList | | SEQUENCE (SIZE (1..maxNrofBWPs) ) OF PUCCH-CSI- |
| Resource | | |
| }, | | |
| semiPersistentOnPUSCH | | SEQUENCE { |
| reportSlotConfig | | ENUMERATED {s15, s110, s120, s140, s180, s1160, |
| s1320}, | | |
| reportSlotOffsetList | | SEQUENCE (SIZE (1.. maxNrofUL-Allocations) ) OF |
| INTEGER (0..32), | | |
| p0alpha | | p0-PUSCH-AlphaSetId |
| }, | | |
| aperiodic | | SEQUENCE { |
| reportSlotOffsetList | | SEQUENCE (SIZE (1..maxNrofUL-Allocations)) OF |
| INTEGER (0..32) | | |
| } | | |
| }, | | |
| nonGroupBasedReportIE | | |
| nonGroupBasedReportID | | INTEGER (0..7) |
| CorsetpoolIndex | INTEGER (0..1) | |
| Timing information | Optional | |

Other reporting information

In accordance with the foregoing, in some embodiments, the second indication may further comprise one or more of: a) a third indication, e.g., CoresetpoolIndex; the third indication may indicate which respective node 111, 112 the one or more respective reference signals are transmitted from, b) a fourth indication; the fourth indication may indicate timing information related to the non-group based reporting, c) a fifth indication; the fifth indication may indicate a panel comprised in the wireless device 130 to be used to receive the one or more respective reference signals; A panel may be e.g., an antenna array with dual polarized elements, d) a sixth indication; the sixth indication may indicate an antenna group to be used by the wireless device 130 to measure the one or more respective reference signals; and e) a seventh indication; the seventh indication may indicate other characteristics for reporting the one or more respective reference signals.

In some embodiments, the timing information may comprise a first maximum time (T), between a first time at which any one of the one or more respective reference signals from the respective node 111, 112 is measured by the wireless device 130 and a second time (t), at which the non-group based report is sent by the wireless device 130 to the respective node 111, 112.

In some embodiments, the timing information may further comprise a second maximum time (To). The second maximum time may be smaller than the first maximum time. Any one of the one or more respective reference signals from the respective node 111, 112 may be measured by the wireless device 130 between the time interval (t-T) and (t-T₀).

The second maximum time (To) may correspond to a processing time or computing time that may be needed by the wireless device 130 to process or compute the non-group based report.

In the examples above, the “nonGroupBasedReportID” and “nonGroupBasedReportIE” may have been configured in “CSI-ReportConfig information element”. However, the configuration may also be done in other places, such as, for example, in “CSI-AperiodicTriggerStateList information element” as defined in 3GPP TS 38.331, version 16.3.1. In yet another example, an explicit list may be configured indicating which CSI report settings may have to be considered for non-group based reporting, and their association with each other. This may for example be configured in “CSI-MeasConfig information element” as defined in 3GPP TS 38.331, version 16.3.1.

In accordance with the foregoing, the second indication may be comprised in one of: a) a CSI-ReportingConfig IE, b) a CSI-AperiodicTriggerStateList information element, and c) a CSI-MeasConfig information element.

In some embodiments, the first node 111 and the second node 112 may operate with a non-ideal backhaul between them. In some of such embodiments, a time difference between the signals received from the first node 111 and the second node 112 may be larger than a duration of a cyclic prefix (CP) used by the wireless device 130.

In one example related to P3 beams sweep, the non-group-based beam reporting may be used for CSI-RS resource set with usage Repetition ‘Off’, e.g., for a P3 beam sweep. In this case, the wireless device 130 may be required to assume that NC-JT may have to be applied over the CSI-RS resources belonging to different TRPs, and try to find UE RX panels/UE RX beams that may maximize the performance for NC-JT.

By obtaining the first indication indicating that non-group based reporting is to be applied to any setting comprising the first indication in this Action 1001, the wireless device 130 may be enabled to perform beam reporting to support mTRP operation with non-ideal backhaul between the plurality of nodes 110, e.g., TRPs, e.g., a multi-DCI based multi-TRP scenario.

Action 1002

In this Action 1002, the wireless device 130 performs measurements on the one or more respective signals received from the respective nodes 111, 112.

By determining performing the measurements the wireless device 130 may then be enabled to report the performed measurements to the respective nodes 111, 112.

Action 1003

In this Action 1003, the wireless device 130 sends, based on the first indication, a non-group based report to the first node 111. The report comprises measurements, of the measurements performed in Action 1002, on the one or more first respective reference signals received from the first node 111, and based on the same first indication, sends another non-group based report to the second node 112, the another non-group based report comprising measurements, of the measurements performed in Action 1002, on one or more second respective reference signals received from the second node 112.

The sending in this Action 1003 may be to. The sending may be performed, e.g., via the first beam 121 to the first node 111, and via the second beam 122 to the second node 112.

It may be understood that in examples wherein the plurality of nodes 110 may comprise additional nodes, the wireless device 130 may send, in this Action 1002, a respective non-group based report comprising respective measurements, of the measurements performed in Action 1002, on one or more additional respective reference signals received from the additional node or nodes.

Examples related to the beam report contents will be provided next.

One problem with non-group based beam reporting according to existing methods is that the gNB does not know if a UE has applied the same or different UE panels, or UE antenna groups, for the reported beams belonging to different CSI report settings. Note that the existing 3GPP RAN1 agreement only states that the UE may be required to be able to receive the beams belonging to different CSI report settings simultaneously, but it is possible that the UE may use the same, analog, beam on the same UE panel, or UE antenna group, when receiving beams from both TRPs. In case the UE uses the same UE panel, or UE antenna group, for both beam groups it may not be possible for the gNB to perform NC-JT from the two TRPs with rank higher than 2, assuming that each UE panel has a maximum of two RX chains. However, the gNB is not aware of this, and may therefore try to schedule the UE with further CSI-reporting from both TRPs in order to facilitate NC-JT, even though it is not possible, which causes unnecessary overhead signaling.

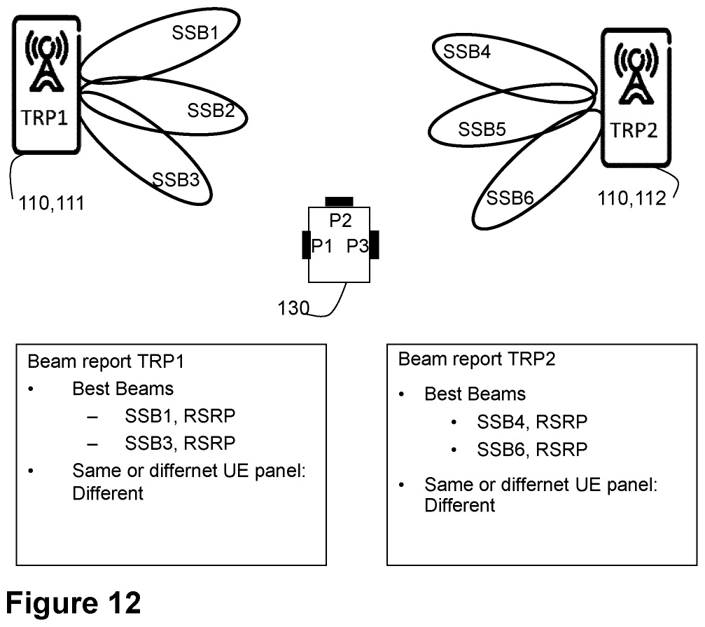

Therefore, in one example of embodiments herein, a flag may be included in the non-group based beam report indicating if the reported beams associated with the different CSI report settings are received with the same or different panels at the wireless device 130, e.g., UE panels. It may be noted that indicating a “virtual UE panel ID” may not be as effective, since then the information of the “virtual UE panel ID” may need to be conveyed between the TRPs for comparison, which may introduce latency and unnecessary overhead in case the two TRPs have non-ideal backhaul. A “virtual UE panel”, may, for example, be a logical index introduced in the specification that may be used to indicate a physical UE panel. This is illustrated in FIG. 12. In the non-limiting example of FIG. 12, the wireless device 130 has three panels: P1, P2 and P3. The first node 111 is a first TPR, TRP1, transmitting three first respective reference signals: SSB1, SSB2 and SSB3 in respective beams. The second node 112 is a second TPR, TRP2, transmitting three second respective reference signals: SSB4, SSB5 and SSB6 in respective beams. The best beams from the first node 111 are those transmitting SSB1 and SSB3. The best beams from the second node 112 are those transmitting SSB4 and SSB6. In the example FIG. 12, the best beam may be understood to refer to the SSB that is received with the highest RSRP. As depicted in FIG. 12, each of the Beam report TRP1 and Beam report TRP2 comprise a flag indicating if the reported beams associated with the different CSI report settings are received with the same or different panels at the wireless device 130, e.g., UE panels. In the depicted example, the panels are indicated to be different.

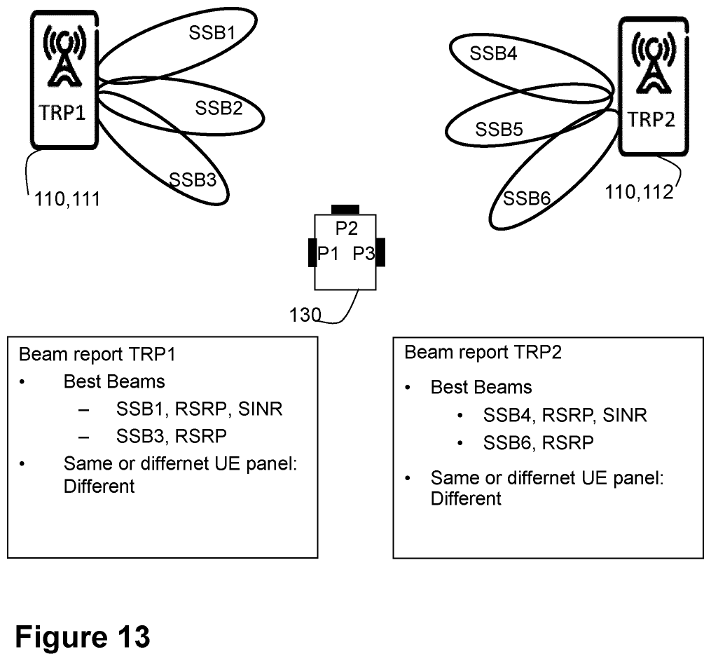

In one example, Signal to Interference Noise Ratio (SINR) may be reported in non-group-based beam reports, either in addition to RSRP, or instead of RSRP. In one alternate of this example, the interference used when calculating SINR may include the interference from the other node in the plurality of nodes 110, e.g., the other TRP, assuming NC-JT may have been scheduled over the two TRPs. Since the inter-TRP interference may vary depending on which beams may be used for each TRP, it may not be straight forward how to determine what SINR may have to be signaled. In one alternate of this example, the wireless device 130 may only calculate SI NR for the first beam pair, that is, the best beam in the beam report associated to the first node 111, e.g., a first TRP, and the best beam in the beam report associated to the second node 112, e.g., the second TRP. This is illustrated in FIG. 13, where SI NR is reported for the best beam in each beam report. In the non-limiting example of FIG. 13, the wireless device 130 has three panels: P1, P2 and P3. The first node 111 is a first TPR, TRP1, transmitting three first respective reference signals: SSB1, SSB2 and SSB3 in respective beams. The second node 112 is a second TPR, TRP2, transmitting three second respective reference signals: SSB4, SSB5 and SSB6 in respective beams. The best beams from the first node 111 are those transmitting SSB1 and SSB3. The best beams from the second node 112 are those transmitting SSB4 and SSB6. The SINR for “Beam report TRP1” is in this example calculated taking the best beam in “Beam report TRP2” into account as interference. In the same way, the SINR included in “Beam report TRP2” for the best beam, may take the interference from the best beam in “Beam report TRP1” into account. In another alternate of this example, the inter node, e.g., inter TRP, interference used when calculating SINR may be defined in a different way, for example, the beam that may generate the worst inter node, e.g., inter-TRP interference may be assumed, or an average interference level from all the beams from the interfering TRP may be used. In the example FIG. 13, the best beam may be understood to refer to the SSB that is received with the highest RSRP. As depicted in FIG. 13, each of the Beam report TRP1 and Beam report TRP2 comprise a flag indicating if the reported beams associated with the different CSI report settings are received with the same or different panels at the wireless device 130, e.g., UE panels. In the depicted example, the panels are indicated to be different.

Examples related to UL mTRP transmissions will be described next.

In Rel-17, support for NC-JT in UL may be supported. It has also been agreed to support UL related beam reports taking maximum permissible exposure (MPE) issues into account, to optimize DL and UL beam pair links independently. In one example, UL related information may be included in the non-group based beam reports. In one alternate of this example, a single MPE related indication may be signaled per node, e.g., TRP. This may assume that the wireless device 130 may use the same UE panel for all the beams of one node, e.g., TRP, and that all beams of that UE panel may be experiencing a similar MPE issue, which may be understood to be quite realistic in many cases, since a human finger that may block a UE panel may be much larger than the UE panel. If the MPE issue differs between the beams of the same UE panel, the UE may either include the MPE related to the best reported UE beam, or the UE beam experience worst MPE, to indicate the worst scenario.

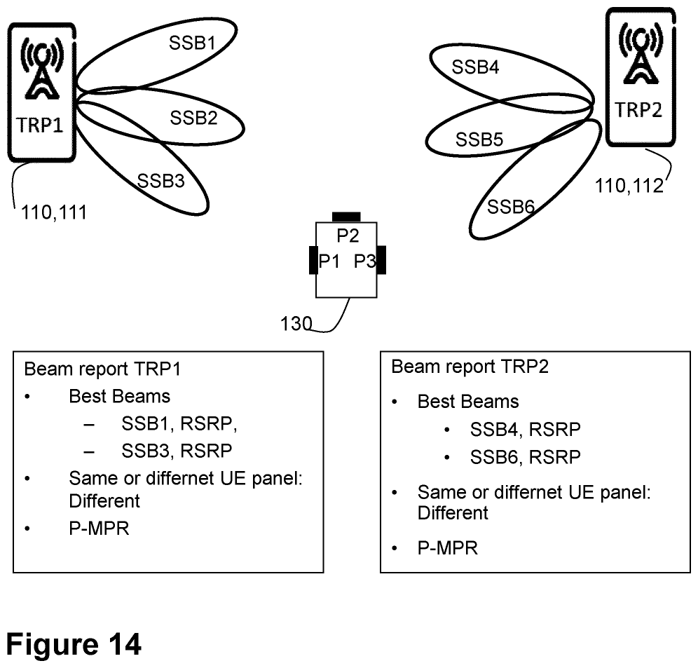

One example of this example is illustrated in FIG. 14, where the wireless device 130 includes one P-MPR value for the UE panel used to receive the beams from one node, e.g., TRP, which differs from how normal beam report may be expected to work, where one UL output power indication may be expected to be signaled per reported gNB beam. It may be noted that other UL related metrics may be possible to be included in the beam report, such as maximum available output power or PHR report, or other information that may indicate the available output power for the associated UE panel. The description of the remaining elements depicted in FIG. 14 may be understood to be the same as that provided for FIG. 12.

In accordance with the foregoing, the report that may be sent to the first node 111 may report information regarding one or more first respective reference signals received from the first node 111. The report sent to the first node 111 may comprise at least one of:
i. an eighth indication; the eight indication may indicate whether or not the one or more first respective reference signals are received using a same or a different panel comprised in the wireless device 130 than a panel used by the wireless device 130 to receive one or more second respective reference signals from the second node 112;
ii. a ninth indication; the ninth indication may indicate a property, e.g., SINR, RSRP, of the one or more first respective reference signals received from the first node 111, as measured by the wireless device 130, and
iii. a tenth indication; the tenth indication may indicate information based on a maximum permissible exposure associated with of one of: a) a respective reference signal using a respective spatial filtering configuration, that is, a respective beam 121, 122, and b) a first panel comprised in the wireless device 130. A respective maximum permissible exposure may be indicated per report.

The another non-group based report sent to the second node 112 may report information regarding one or more second respective reference signals received from the second node 112. The report sent to the second node 112 may comprise corresponding information to that described for the first node 111, but pertaining to the one or more second respective reference signals received from the second node 112.

By sending the non-group based report to the first node 111 and the another non-group based report to the second node 112 in this Action 1002, the wireless device 130 may be enabled to perform beam reporting to support mTRP operation with non-ideal backhaul between the plurality of nodes 110, e.g., TRPs, e.g., a multi-DCI based multi-TRP scenario.

Embodiments of a method performed by the first node 111, will now be described with reference to the flowchart depicted in FIG. 15. The method may be understood to be for handling the first indication. The first node 111 operates in the wireless communications network 100.

The method may comprise one or more of the following actions. In some embodiments, one action may be performed. In some embodiments, all the actions may be performed. One or more embodiments or examples may be combined, where applicable. All possible combinations are not described to simplify the description. It should be noted that the examples herein are not mutually exclusive. Components from one example may be tacitly assumed to be present in another example and it will be obvious to a person skilled in the art how those components may be used in the other examples. A non-limiting example of the method performed by the first node 111 is depicted in FIG. 15.

The detailed description of some of the following corresponds to the same references provided above, in relation to the actions described for the wireless device 130 and will thus not be repeated here. For example, the reference signal may be e.g., a Channel State Information Reference signal, CSI-RS, a NZP CSI-RS or an SSB.

Action 1501

In this Action 1501, the first node 111 sends the first indication to the wireless device 130 operating in the wireless communications network 100. The first indication indicates that non-group based reporting is to be applied to any setting comprising the first indication. That is, the first indication may indicate that non-group based reporting is to be applied to any setting comprising the same first indication. As stated earlier, a setting may be understood as a configuration.

Non-group based reporting may be understood as reporting comprising sending a separate, or individual, report to different nodes, e.g., to different TRPs, on respective reference signals which may be respectively received by the wireless device 130 from the different nodes in a same set of time resources, that is, simultaneously.

The setting indicates how to report, to the respective node 111, 112, the information on the one or more respective reference signals to be received from the respective node 111, 112. The reference signals use the one or more respective beams 121, 122, of the respective node 111, 112. That is, the setting may be understood to be, or may be understood to be referred to as a “report setting” or “report configuration”. The report setting may be, for example, as described in 3GPP TS 38.311, version 16.3.1.

The respective node 111, 112 is comprised in the plurality of nodes 110 comprising the first node 111 and at least the second node 112.

For example, the setting may indicate how to report, to the first node 111, information on a respective reference signal to be received from the first node 111 on the first beam 111.

The reference signal may be e.g., a CSI-RS.

The sending in this Action 1501 may be performed, e.g., via the first beam 121.

Each beam may correspond to a respective spatial filtering configuration of the respective node 111, 112.

The first indication may indicate that the wireless device 130 is to ensure that the respective reference signals to be received, e.g., on the respective beams 121, 122 that is, the respective reference signals using the respective spatial filtering configurations, are enabled to be received in the same time resources, e.g., and/or frequency resources, e.g., simultaneously, from the respective nodes 111, 112, by the wireless device 130, e.g., in different beams such as the first beam 121 and the second beam 122.

Each of the respective nodes 111, 112, may be indicated by, or represented by, one of a: TRP, radio head, spatial relation, Transmission Configuration Indication state, Non-zero power Chanel State Information-Reference Signal resource set, Coresetpoolindex and an identifier. For example, the first node 111, may be indicated by, or represented by, one of a first: TRP, radio head, spatial relation, Transmission Configuration Indication state, Non-zero power Chanel State Information-Reference Signa resource set, Coresetpoolindex and identifier.

The first indication may indicate an association between the respective reference signals on the respective beams 121, 122, and/or between report settings.

In some embodiments, the first indication may be the nonGroupBasedReportID, e.g., as described earlier.

The first indication may be comprised in the CSI report setting.

In some embodiments, the first indication may be comprised in the second indication.

The second indication may be the IE comprising at least the ID indicating the non-group based report, and at least the third indication indicating which respective node 111, 112 the one or more respective reference signals are transmitted from.

The second indication may be the nonGroupBasedReportIE, e.g., as described earlier.

In some embodiments, the second indication may be comprised in one of: a) the CSI-ReportingConfig IE, b) the CSI-AperiodicTriggerStateList information element, and c) the CSI-MeasConfig information element.

In some embodiments, the second indication may further comprise one or more of: a) the third indication, e.g., CoresetpoolIndex; the third indication may indicate which respective node 111, 112 the one or more respective reference signals are transmitted from, b) the fourth indication; the fourth indication may indicate timing information related to the non-group based reporting, c) the fifth indication; the fifth indication may indicate the panel comprised in the wireless device 130 to be used to receive the one or more respective reference signals; A panel may be e.g., an antenna array with dual polarized elements, d) the sixth indication; the sixth indication may indicate the antenna group to be used by the wireless device 130 to measure the one or more respective reference signals; and e) the seventh indication; the seventh indication may indicate other characteristics for reporting the one or more respective reference signals.

In some embodiments, the timing information may comprise the first maximum time (T), between the first time at which any one of the one or more respective reference signals from the respective node 111, 112 is measured by the wireless device 130 and the second time (t), at which the non-group based report is sent by the wireless device 130 to the respective node 111, 112.

In some embodiments, the timing information may further comprise the second maximum time (T₀). The second maximum time may be smaller than the first maximum time. Any one of the one or more respective reference signals from the respective node 111, 112 may have to be measured by the wireless device 130 between the time interval (t-T) and (t-T₀).

The second maximum time (To) may correspond to the processing time or computing time that may be needed by the wireless device 130 to process or compute the non-group based report.

In some embodiments, the first node 111 and the second node 112 may operate with the non-ideal backhaul between them. In some of such embodiments, the time difference between the signals transmitted from the first node 111 and the second node 112 may be larger than the duration of the CP used by the wireless device 130.

In some embodiments, the second indication may further comprise one or more of:
the third indication, e.g., CoresetpoolIndex; the third indication may indicate which respective node 111, 112 the respective reference signal is transmitted from;
the fourth indication; the fourth indication may indicate timing information related to the non-group based reporting;
the fifth indication; the fifth indication may indicate the panel comprised in the wireless device 130 to be used to receive the respective reference signal; A panel may be e.g., an antenna array with dual polarized elements;
the sixth indication; the sixth indication may indicate the antenna group to be used by the wireless device 130 to measure the respective reference signal; and
the seventh indication; the seventh indication may indicate other characteristics for reporting the respective reference signal.

Action 1502

In this Action 1502, the first node 111 receives, based on the first indication, the non-group based report from the wireless device 130. The report comprises measurements on the one or more first respective reference signals transmitted by the first node 111. Based on the same first indication, another non-group based report is sent to the second node 112 by the wireless device 130. The another non-group based report comprises measurements on the one or more second respective reference signals received by the wireless device 130 from the second node 112.

The receiving in this Action 1102 may be from the wireless device 130. The receiving may be performed, e.g., via the first beam 121.

In some embodiments, the report that may be received by the first node 111 may report the information regarding one or more first respective reference signals sent by the first node 111 and received by the wireless device 130. The report received by the first node 111 may comprise at least one of:
i. the eighth indication; the eight indication may indicate whether or not the one or more first respective reference signals are received by the wireless device 130 using the same or a different panel comprised in the wireless device 130 than the panel used by the wireless device 130 to receive one or more second respective reference signals from the second node 112;
ii. the ninth indication; the ninth indication may indicate the property, e.g., SI NR, RSRP, of the one or more first respective reference signals sent by the first node 111, as measured by the wireless device 130, and
iii. the tenth indication; the tenth indication may indicate the information based on the maximum permissible exposure associated with of one of: a) the respective reference signal using the respective spatial filtering configuration, that is, a respective beam 121, 122 sent by the first node 111, and b) the first panel comprised in the wireless device 130. The respective maximum permissible exposure may be indicated per report.

The another non-group based report sent to the second node 112 may report information regarding the one or more second respective reference signals received from the second node 112 by the wireless device 130. The report sent to the second node 112 may comprise corresponding information to that described for the first node 111, but pertaining to the one or more second respective reference signals received from the second node 112.

As a summarized overview of the above, embodiments herein may be understood to describe a framework to enable non group-based beam reporting for mTRP scenarios.

Certain embodiments disclosed herein may provide one or more of the following technical advantage(s), which may be summarized as follows. Embodiments herein may be understood to enable beam reporting to support mTRP operation with non-ideal backhaul between the TRPs, e.g., a multi-DCI based multi-TRP scenario.

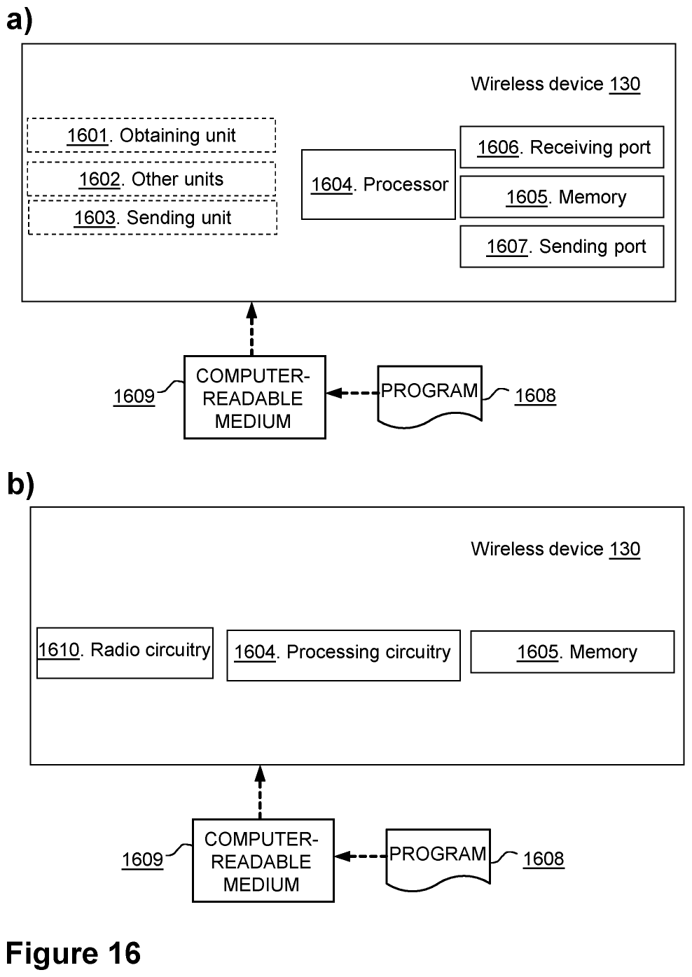

FIG. 16 depicts two different examples in panels a) and b), respectively, of the arrangement that the wireless device 130 may comprise to perform the method actions described above in relation to FIG. 10. In some embodiments, the wireless device 130 may comprise the following arrangement depicted in FIG. 16a. The wireless device 130 may be understood to be for handling the first indication. The wireless device 130 is configured to operate in the wireless communications network 100.

Several embodiments are comprised herein. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the wireless device 130, and will thus not be repeated here. For example, the reference signal may be e.g., a Channel State Information Reference signal, CSI-RS, a NZP CSI-RS or an SSB.

In FIG. 16, optional units are indicated with dashed boxes.

The wireless device 130 may be configured to perform the obtaining of Action 1001, e.g., by means of an, obtaining unit 1601 within the wireless device 130, configured to, obtain the first indication. The first indication is configured to indicate that non-group based reporting is to be applied to any setting comprising the first indication. The setting is configured to indicate how to report, to the respective node 111, 112, the information on the one or more respective reference signals configured to be received from the respective node 111, 112. The reference signals are configured to use the one or more respective beams 121, 122 of the respective node 111, 112. The respective node 111, 112 is configured to be comprised in the plurality of nodes 110 configured to comprise the first node 111 and at least the second node 112.

The obtaining unit 1601 may be the processor 1604 of the wireless device 130, or an application running on such processor.

The wireless device 130 is also configured to perform the performing of Action 1002, e.g. by means of another unit, of the other units 1602 that may be comprised in the wireless device 130, within the first node 111 configured to, perform measurements on the one or more respective signals configured to be received from the respective nodes 111, 112.

The wireless device 130 may be configured to perform the sending of Action 1003, e.g. by means of a sending unit 1603, configured to, send, based on the first indication, the non-group based report to the first node 111. The report is configured to comprise measurements on the one or more first respective reference signals configured to be received from the first node 111, and based on the same first indication, send the another non-group based report to the second node 112. The another non-group based report is configured to comprise measurements on the one or more second respective reference signals configured to be received from the second node 112.

The sending unit 1602 may be a processor 1604 of the wireless device 130, or an application running on such processor.

In some embodiments, each beam may be configured to correspond to the respective spatial filtering configuration of the respective node 111, 112.

In some embodiments, the first indication may be configured to indicate that the wireless device 130 is to ensure that the respective reference signals configured to be received, the respective reference signals being configured to use the respective spatial filtering configurations, are enabled to be received in the same time resources from the respective nodes 111, 112, by the wireless device 130.

In some embodiments, each of the respective nodes 111, 112, may be configured to be represented by one of a: TRP, radio head, spatial relation, Transmission Configuration Indication state, Non-zero power CSI-Reference Signal resource set, Coresetpoolindex and an identifier.

In some embodiments, the first indication may be configured to be the nonGroupBasedReportl D.

In some embodiments, the first indication may be configured to be comprised in a CSI report setting.

In some embodiments, the first indication may be configured to be comprised in the second indication.

In some embodiments, the second indication may be configured to be the IE configured to comprise at least the ID configured to indicate the non-group based report, and at least the third indication configured to indicate which respective node 111, 112 the one or more respective reference signals are transmitted from.

In some embodiments, the second indication may be configured to be the nonGroupBasedReportIE.

In some embodiments, the second indication may be configured to be comprised in one of: a) the CSI-ReportingConfig IE, b) the CSI-AperiodicTriggerStateList information element, and c) the CSI-MeasConfig information element.

In some embodiments, the second indication may be further configured to comprise one or more of: a) the third indication configured to indicate which respective node 111, 112 the one or more respective reference signals are transmitted from, b) the fourth indication configured to indicate timing information configured to be related to the non-group based reporting, c) the fifth indication configured to indicate the panel configured to be comprised in the wireless device 130 and configured to be used to receive the one or more respective reference signals, d) the sixth indication configured to indicate the antenna group configured to be used by the wireless device 130 to measure the one or more respective reference signals; and e) the seventh indication configured to indicate other characteristics for reporting the one or more respective reference signals.

In some embodiments, the timing information may be configured to comprise the first maximum time, T, between the first time at which any one of the one or more respective reference signals from the respective node 111, 112 may be configured to be measured by the wireless device 130 and may be second time, t, at which the non-group based report may be configured to be sent by the wireless device 130 to the respective node 111, 112.

In some embodiments, the timing information may be further configured to comprise the second maximum time, T₀, wherein the second maximum time may be configured to be smaller than the first maximum time, and any one of the one or more respective reference signals from the respective node 111, 112 may be configured to be measured by the wireless device 130 between the time interval t-T and t-T₀.

In some embodiments, the second maximum time, T₀, may be configured to correspond to the processing time or computing time configured to be needed by the wireless device 130 to process or compute the non-group based report.

In some embodiments, the report configured to be sent to the first node 111 may be configured to comprise at least one of: i) the eighth indication configured to indicate whether or not the one or more first respective reference signals may be configured to be received by the wireless device 130 using the same or a different panel configured to be comprised in the wireless device 130 than the panel configured to be used by the wireless device 130 to receive the one or more second respective reference signals from the second node 112; ii) the ninth indication configured to indicate the property of the one or more first respective reference signals configured to be received from the first node 111, as configured to be measured by the wireless device 130, and iii) the tenth indication configured to indicate information based on the maximum permissible exposure configured to be associated with one of: a) the respective reference signal configured to be using the respective spatial filtering configuration, and b) the first panel configured to be comprised in the wireless device 130, wherein the respective maximum permissible exposure may be configured to be indicated per report.

In some embodiments, the first node 111 and the second node 112 may be configured to operate with the non-ideal backhaul between them. The time difference between the signals configured to be received from the first node 111 and the second node 112 may be configured to be larger than the duration of the CP used by the wireless device 130.

The embodiments herein in the wireless device 130 may be implemented through one or more processors, such as a processor 1604 in the wireless device 130 depicted in FIG. 16a, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the wireless device 130. One such carrier may be in the form of a CD ROM disc. It is however feasible with other data carriers such as a memory stick. The computer program code may furthermore be provided as pure program code on a server and downloaded to the wireless device 130.

The wireless device 130 may further comprise a memory 1605 comprising one or more memory units. The memory 1605 is arranged to be used to store obtained information, store data, configurations, schedulings, and applications etc. to perform the methods herein when being executed in the wireless device 130.

In some embodiments, the wireless device 130 may receive information from, e.g., the first node 111, the second node 112, the network node 110, the host computer 2110, or any of the other nodes, through a receiving port 1606. In some embodiments, the receiving port 1606 may be, for example, connected to one or more antennas in wireless device 130. In other embodiments, the wireless device 130 may receive information from another structure in the wireless communications network 100 through the receiving port 1606. Since the receiving port 1606 may be in communication with the processor 1604, the receiving port 1606 may then send the received information to the processor 1604. The receiving port 1606 may also be configured to receive other information.

The processor 1604 in the wireless device 130 may be further configured to transmit or send information to e.g., the first node 111, the second node 112, the network node 110, the host computer 2110, or any of the other nodes, or another structure in the wireless communications network 100, through a sending port 1607, which may be in communication with the processor 1604, and the memory 1605.

Those skilled in the art will also appreciate that the different units 1601-1603 described above may refer to a combination of analog and digital modules, and/or one or more processors configured with software and/or firmware, e.g., stored in memory, that, when executed by the one or more processors such as the processor 1604, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different units 1601-1603 described above may be implemented as one or more applications running on one or more processors such as the processor 1604.

Thus, the methods according to the embodiments described herein for the wireless device 130 may be respectively implemented by means of a computer program 1608 product, comprising instructions, i.e., software code portions, which, when executed on at least one processor 1604, cause the at least one processor 1604 to carry out the actions described herein, as performed by the wireless device 130. The computer program 1608 product may be stored on a computer-readable storage medium 1609. The computer-readable storage medium 1609, having stored thereon the computer program 1608, may comprise instructions which, when executed on at least one processor 1604, cause the at least one processor 1604 to carry out the actions described herein, as performed by the wireless device 130. In some embodiments, the computer-readable storage medium 1609 may be a non-transitory computer-readable storage medium, such as a CD ROM disc, or a memory stick. In other embodiments, the computer program 1608 product may be stored on a carrier containing the computer program 1608 just described, wherein the carrier is one of an electronic signal, optical signal, radio signal, or the computer-readable storage medium 1609, as described above.

The wireless device 130 may comprise a communication interface configured to facilitate communications between the wireless device 130 and other nodes or devices, e.g., the first node 111, the second node 112, the network node 110, the host computer 2110, or any of the other nodes. The interface may, for example, include a transceiver configured to transmit and receive radio signals over an air interface in accordance with a suitable standard.

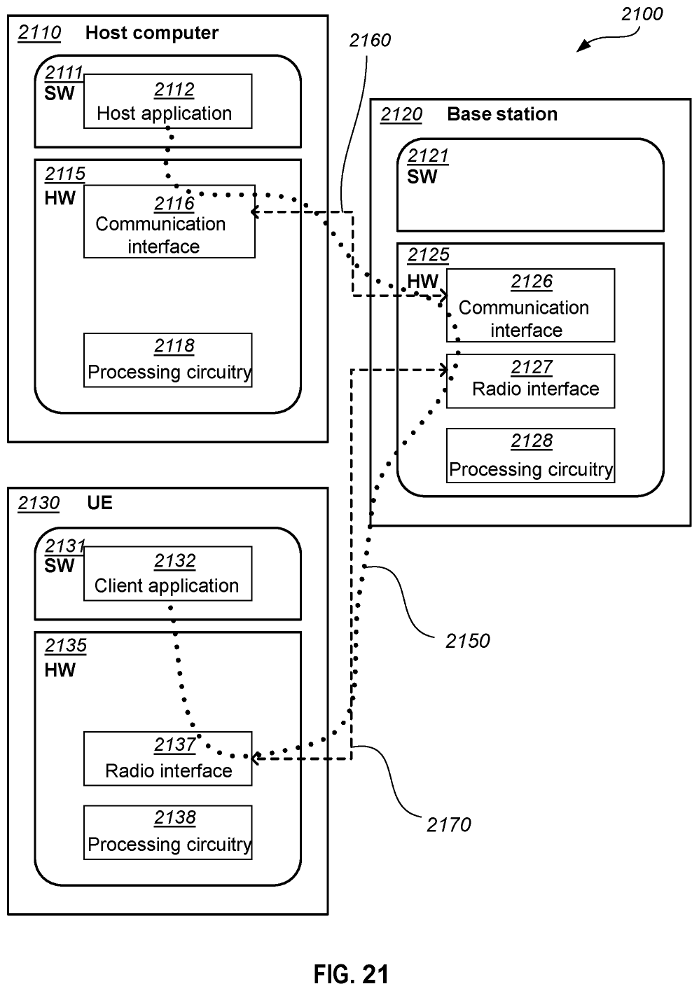

In other embodiments, the wireless device 130 may comprise the following arrangement depicted in FIG. 16b. The wireless device 130 may comprise a processing circuitry 1604, e.g., one or more processors such as the processor 1604, in the wireless device 130 and the memory 1605. The wireless device 130 may also comprise a radio circuitry 1610, which may comprise e.g., the receiving port 1606 and the sending port 1607. The processing circuitry 1604 may be configured to, or operable to, perform the method actions according to FIG. 10 and/or FIGS. 21-25, in a similar manner as that described in relation to FIG. 16a. The radio circuitry 1610 may be configured to set up and maintain at least a wireless connection with the first node 111, the second node 112, the network node 110, the host computer 2110, or any of the other nodes. Circuitry may be understood herein as a hardware component.

Hence, embodiments herein also relate to the wireless device 130 comprising the processing circuitry 1604 and the memory 1605, said memory 1605 containing instructions executable by said processing circuitry 1604, whereby the wireless device 130 is operative to perform the actions described herein in relation to the wireless device 130, e.g., in FIG. 10, and/or FIGS. 21-25.

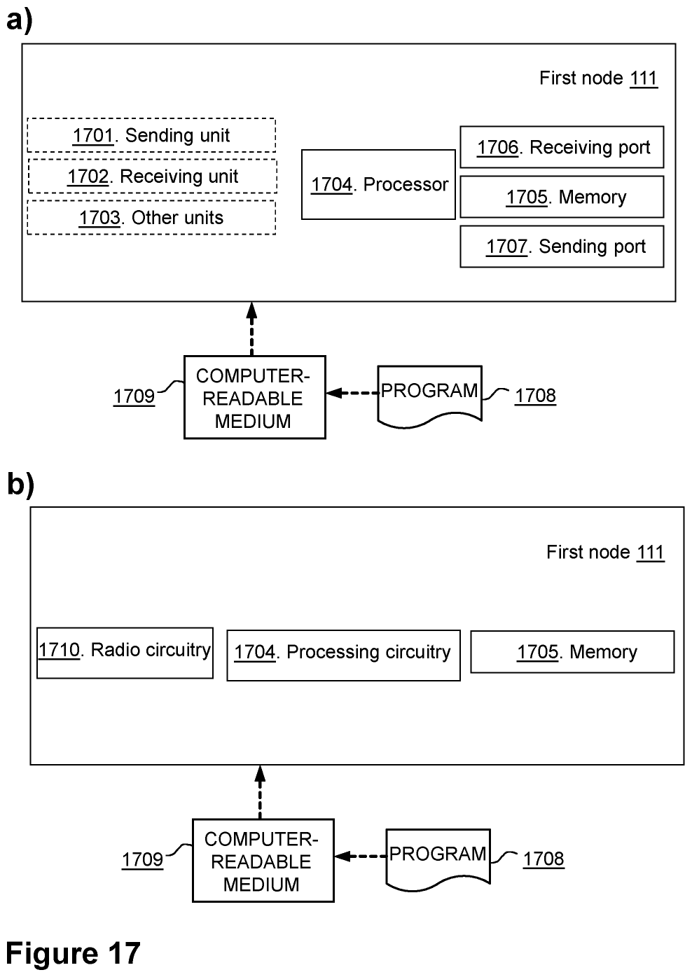

FIG. 17 depicts two different examples in panels a) and b), respectively, of the arrangement that the first node 111 may comprise to perform the method actions described above in relation to FIG. 15 and/or FIGS. 21-25. In some embodiments, the first node 111 may comprise the following arrangement depicted in FIG. 17a. The first node 111 may be understood to be for handling the first indication. The first node 111 is configured to operate in the wireless communications network 100.

Several embodiments are comprised herein. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the wireless device 130, and will thus not be repeated here. For example, the reference signal may be e.g., a Channel State Information Reference signal, CSI-RS, a NZP CSI-RS or an SSB.

In FIG. 17, optional units are indicated with dashed boxes.

The first node 111 may be configured to perform the sending of Action 1102, e.g. by means of a sending unit 1701 within the first node 111, configured to, send the first indication to the wireless device 130 configured to operate in the wireless communications network 100. The first indication is configured to indicate that non-group based reporting is to be applied to any setting comprising the first indication. The setting is configured to indicate how to report, to the respective node 111, 112, the information on the one or more respective reference signals configured to be received from the respective node 111, 112. The reference signals are configured to use the one or more respective beams 121, 122, of the respective node 111, 112. The respective node 111, 112 is configured to be comprised in the plurality of nodes 110 configured to comprise the first node 111 and at least the second node 112.

The first node 111 may be configured to perform the receiving of Action 1102, e.g. by means of a receiving unit 1702, configured to, receive, based on the first indication, the non-group based report from the wireless device 130. The report is configured to comprise the measurements on the one or more first respective reference signals configured to be transmitted by the first node 111. Based on the same first indication, the another non-group based report is configured to be sent to the second node 112 by the wireless device 130. The another non-group based report is configured to comprise the measurements the on one or more second respective reference signals configured to be received by the wireless device 130 from the second node 112.

The receiving unit 1702 may be a processor 1704 of the first node 111, or an application running on such processor.

In some embodiments, each beam may be configured to correspond to the respective spatial filtering configuration of the respective node 111, 112.

In some embodiments, the first indication may be configured to indicate that the wireless device 130 is to ensure that the respective reference signals configured to be received, the respective reference signals being configured to use the respective spatial filtering configurations, are enabled to be received in the same time resources from the respective nodes 111, 112, by the wireless device 130.

In some embodiments, each of the respective nodes 111, 112, may be configured to be represented by one of a: TRP, radio head, spatial relation, Transmission Configuration Indication state, Non-zero power CSI-Reference Signal resource set, Coresetpoolindex and an identifier.

In some embodiments, the first indication may be configured to be the nonGroupBasedReportl D.

In some embodiments, the first indication may be configured to be comprised in the CSI report setting.

In some embodiments, the first indication may be configured to be comprised in the second indication.

In some embodiments, the second indication may be configured to be the IE configured to comprise at least the ID configured to indicate the non-group based report, and at least the third indication configured to indicate which respective node 111, 112 the one or more respective reference signals are transmitted from.

In some embodiments, the second indication may be configured to be the nonGroupBasedReportIE.

In some embodiments, the second indication may be configured to be comprised in one of: a) the CSI-ReportingConfig IE, b) the CSI-AperiodicTriggerStateList information element, and c) the CSI-MeasConfig information element.

In some embodiments, the second indication may be further configured to comprise one or more of: a) the third indication configured to indicate which respective node 111, 112 the one or more respective reference signals are transmitted from, b) the fourth indication configured to indicate timing information configured to be related to the non-group based reporting, c) the fifth indication configured to indicate the panel configured to be comprised in the wireless device 130 and configured to be used to receive the one or more respective reference signals, d) the sixth indication configured to indicate the antenna group configured to be used by the wireless device 130 to measure the one or more respective reference signals; and e) the seventh indication configured to indicate other characteristics for reporting the one or more respective reference signals.

In some embodiments, the timing information may be configured to comprise the first maximum time, T, between the first time at which any one of the one or more respective reference signals from the respective node 111, 112 may be configured to be measured by the wireless device 130 and may be second time, t, at which the non-group based report may be configured to be sent by the wireless device 130 to the respective node 111, 112.

In some embodiments, the timing information may be further configured to comprise the second maximum time, T₀, wherein the second maximum time may be configured to be smaller than the first maximum time, and any one of the one or more respective reference signals from the respective node 111, 112 may be configured to be measured by the wireless device 130 between the time interval t-T and t-T₀.

In some embodiments, the second maximum time, T₀, may be configured to correspond to the processing time or computing time configured to be needed by the wireless device 130 to process or compute the non-group based report.

In some embodiments, the report configured to be received by the first node 111 may be configured to comprise at least one of: i) the eighth indication configured to indicate whether or not the one or more first respective reference signals may be configured to be received by the wireless device 130 using the same or a different panel configured to be comprised in the wireless device 130 than the panel configured to be used by the wireless device 130 to receive the one or more second respective reference signals from the second node 112; ii) the ninth indication configured to indicate the property of the one or more first respective reference signals configured to be sent by the first node 111, as configured to be measured by the wireless device 130, and iii) the tenth indication configured to indicate information based on the maximum permissible exposure configured to be associated with one of: a) the respective reference signal configured to be using the respective spatial filtering configuration, and b) the first panel configured to be comprised in the wireless device 130, wherein the respective maximum permissible exposure may be configured to be indicated per report.

In some embodiments, the first node 111 and the second node 112 may be configured to operate with the non-ideal backhaul between them. The time difference between the signals configured to be transmitted from the first node 111 and the second node 112 may be configured to be larger than the duration of the CP used by the wireless device 130.

Other units 1703 may be comprised in the first node 111.

The embodiments herein in the first node 111 may be implemented through one or more processors, such as a processor 1704 in the first node 111 depicted in FIG. 17a, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the first node 111. One such carrier may be in the form of a CD ROM disc. It is however feasible with other data carriers such as a memory stick. The computer program code may furthermore be provided as pure program code on a server and downloaded to the first node 111.

The first node 111 may further comprise a memory 1705 comprising one or more memory units. The memory 1705 is arranged to be used to store obtained information, store data, configurations, schedulings, and applications etc. to perform the methods herein when being executed in the first node 111.

In some embodiments, the first node 111 may receive information from, e.g., the second node 112, the network node 110, the wireless device 130, the host computer 2110, or any of the other nodes, through a receiving port 1706. In some embodiments, the receiving port 1706 may be, for example, connected to one or more antennas in first node 111. In other embodiments, the first node 111 may receive information from another structure in the wireless communications network 100 through the receiving port 1706. Since the receiving port 1706 may be in communication with the processor 1704, the receiving port 1706 may then send the received information to the processor 1704. The receiving port 1706 may also be configured to receive other information.

The processor 1704 in the first node 111 may be further configured to transmit or send information to e.g., the second node 112, the network node 110, the wireless device 130, the host computer 2110, or any of the other nodes, or another structure in the wireless communications network 100, through a sending port 1707, which may be in communication with the processor 1704, and the memory 1705.

Those skilled in the art will also appreciate that the different units 1701-1703 described above may refer to a combination of analog and digital modules, and/or one or more processors configured with software and/or firmware, e.g., stored in memory, that, when executed by the one or more processors such as the processor 1704, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different units 1701-1703 described above may be implemented as one or more applications running on one or more processors such as the processor 1704.

Thus, the methods according to the embodiments described herein for the first node 111 may be respectively implemented by means of a computer program 1708 product, comprising instructions, i.e., software code portions, which, when executed on at least one processor 1704, cause the at least one processor 1704 to carry out the actions described herein, as performed by the first node 111. The computer program 1708 product may be stored on a computer-readable storage medium 1709. The computer-readable storage medium 1709, having stored thereon the computer program 1708, may comprise instructions which, when executed on at least one processor 1704, cause the at least one processor 1704 to carry out the actions described herein, as performed by the first node 111. In some embodiments, the computer-readable storage medium 1709 may be a non-transitory computer-readable storage medium, such as a CD ROM disc, or a memory stick. In other embodiments, the computer program 1708 product may be stored on a carrier containing the computer program 1708 just described, wherein the carrier is one of an electronic signal, optical signal, radio signal, or the computer-readable storage medium 1709, as described above.

The first node 111 may comprise a communication interface configured to facilitate communications between the first node 111 and other nodes or devices, e.g., the second node 112, the network node 110, the wireless device 130, the host computer 2110, or any of the other nodes. The interface may, for example, include a transceiver configured to transmit and receive radio signals over an air interface in accordance with a suitable standard.

In other embodiments, the first node 111 may comprise the following arrangement depicted in FIG. 17b. The first node 111 may comprise a processing circuitry 1704, e.g., one or more processors such as the processor 1704, in the first node 111 and the memory 1705. The first node 111 may also comprise a radio circuitry 1710, which may comprise e.g., the receiving port 1706 and the sending port 1707. The processing circuitry 1710 may be configured to, or operable to, perform the method actions according to FIG. 15 and/or FIGS. 21-25, in a similar manner as that described in relation to FIG. 17a. The radio circuitry 1710 may be configured to set up and maintain at least a wireless connection with the second node 112, the network node 110, the wireless device 130, the host computer 1110, or any of the other nodes. Circuitry may be understood herein as a hardware component.

Hence, embodiments herein also relate to the first node 111 comprising the processing circuitry 1704 and the memory 1705, said memory 1705 containing instructions executable by said processing circuitry 1704, whereby the first node 111 is operative to perform the actions described herein in relation to the first node 111, e.g., in FIG. 15 and/or FIGS. 21-25.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa.

Other objectives, features and advantages of the enclosed embodiments will be apparent from the following description.

As used herein, the expression “at least one of:” followed by a list of alternatives separated by commas, and wherein the last alternative is preceded by the “and” term, may be understood to mean that only one of the list of alternatives may apply, more than one of the list of alternatives may apply or all of the list of alternatives may apply. This expression may be understood to be equivalent to the expression “at least one of:” followed by a list of alternatives separated by commas, and wherein the last alternative is preceded by the “or” term.

### Examples Related to Embodiments Herein

More specifically, the following are embodiments related to a wireless device, such as the wireless device 130, e.g., a UE, and embodiments related to a node, such as the first node 111, e.g., a TRP.

The wireless device 130 embodiments relate to FIG. 10, FIGS. 11-14, FIGS. 16, and FIGS. 20-25.

A method, performed by a wireless device, such as the wireless device 130 is described herein. The method may be understood to be handling a first indication. The wireless device 130 may be operating in the wireless communications network 100.

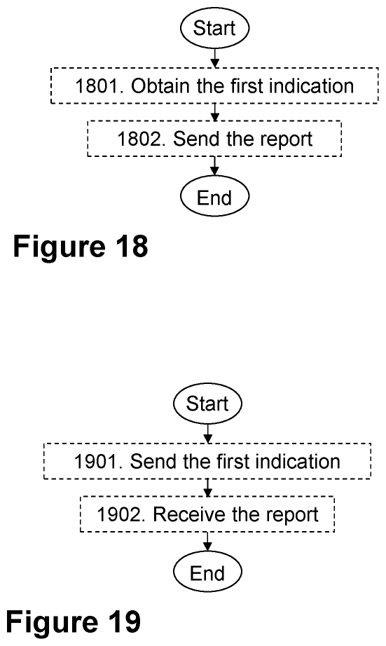

The method may comprise one or more of the following actions. In some embodiments, one action may be performed. In some embodiments, all the actions may be performed. One or more embodiments or examples may be combined, where applicable. All possible combinations are not described to simplify the description. A non-limiting example of the method performed by the wireless device 130 is depicted in FIG. 18.
Obtaining 1801 an indication, e.g., a first indication. The wireless device 130 may be configured to perform this obtaining action 1801, e.g., by means of an obtaining unit 1601 within the wireless device 130, configured to perform this action. The obtaining unit 1601 may be the processor 1604 of the wireless device 130, or an application running on such processor.

Obtaining in this Action 1801 may comprise receiving, e.g., from the first node 111, from the network node 115, or from another node operating in the wireless communications network 100, or retrieving from a memory storage, e.g., comprised in the wireless device 130.

The obtaining in this Action 1801 may be performed, e.g., via the first beam 121, or the link 141.

The first indication may be received from the first node 111.

The first indication may indicate that non-group based reporting is to be applied to any setting comprising the same first indication.

A setting may be understood as a configuration.

The setting may indicate how to report, to a respective node 111, 112, information on a respective reference signal to be received from the respective node 111, 112 on a respective beam 121, 122. That is, the setting may be understood to be, or may be understood to be referred to as a “report setting” or “report configuration”. The report setting may be, for example, as described in 3GPP TS 38.331.

The reference signal may be e.g., a Channel State Information Reference signal, CSI-RS, a NZP CSI-RS or an SSB.

The respective node 111, 112 may be comprised in the set of nodes 110 comprising the first node 111 and at least the second node 112.

Each of the respective nodes 111, 112, may be indicated by, or represented by, one of a: TRP, radio head, spatial relation, Transmission Configuration Indication state, Non-zero power Chanel State Information-Reference Signa resource set, Coresetpoolindex and an identifier.

The first indication may indicate an association between the respective reference signals on the respective beams 121, 122, and/or between report settings.

The first indication may indicate that the wireless device 130 is to ensure that the respective reference signals on the respective beams 121, 122 are enabled to be received in the same time and/or frequency resources, e.g., simultaneously, from the respective nodes 111, 112, by the wireless device 130, e.g., in different beams such as the first beam 121 and the second beam 122.

In some embodiments, the first indication may be a nonGroupBasedReportID, e.g., as described later.

The first indication may be comprised in a CSI report setting.

In some embodiments, the first indication may be comprised in a second indication.

The second indication may be a nonGroupBasedReportl E, e.g., as described later.

The second indication may be comprised in one of:
a CSI-ReportingConfig IE;
a CSI-AperiodicTriggerStateList information element; and
a CSI-MeasConfig information element.

In some embodiments, the second indication may further comprise one or more of:
a third indication, e.g., CoresetpoolIndex; the third indication may indicate which respective node 111, 112 the respective reference signal is transmitted from;
a fourth indication; the fourth indication may indicate timing information related to the non-group based reporting;
a fifth indication; the fifth indication may indicate a panel comprised in the wireless device 130 to be used to receive the respective reference signal; A panel may be e.g., an antenna array with dual polarized elements;
a sixth indication; the sixth indication may indicate an antenna group to be used by the wireless device 130 to measure the respective reference signal; and
a seventh indication; the seventh indication may indicate other characteristics for reporting the respective reference signal.

In some embodiments, the method may further comprise:
Sending 1802 a report, e.g., a non-group based report. The wireless device 130 may be configured to perform this sending action 1802, e.g. by means of a sending unit 1602, configured to perform this action. The sending unit 1602 may be a processor 1604 of the wireless device 130, or an application running on such processor.

The sending in this Action 1802 may be to the first node 111. The sending may be performed, e.g., via the first beam 121.

The report may report information regarding one or more first respective reference signals received from the first node 111. The report may comprise at least one of:
i. an eighth indication; the eight indication may indicate whether or not the one or more first respective reference signals are received using a same or a different panel comprised in the wireless device 130 than a panel used by the wireless device 130 to receive one or more second respective reference signals from the second node 112;
ii. a ninth indication; the ninth indication may indicate a property, e.g., SINR, RSRP, of the first respective reference signal received from the first node 111, as measured by the wireless device 130, and
iii. a tenth indication; the tenth indication may indicate information based on a maximum permissible exposure of one of: a) a respective beam 121, 122, e.g., received by the wireless device 130, and b) a first panel comprised in the wireless device 130.

Other units 1603 may be comprised in the wireless device 130.

In FIG. 16, optional units are indicated with dashed boxes.

The first node 111 embodiments relate to FIG. 19, FIGS. 11-14, FIG. 17, and FIGS. 20-25.

A method, performed by a node, e.g., first node, such as the first node 111, is described herein. The method may be understood to be for handling a first indication. The first node 111 may be operating in the wireless communications network 100.

The method may comprise one or more of the following actions. In some embodiments, one action may be performed. In some embodiments, all the actions may be performed. One or more embodiments or examples may be combined, where applicable. All possible combinations are not described to simplify the description. A non-limiting example of the method performed by the first node 111 is depicted in FIG. 19. Optional actions are indicated with dashed boxes.

The detailed description of some of the following corresponds to the same references provided above, in relation to the actions described for the wireless device 130 and will thus not be repeated here. For example, the reference signal may be e.g., a Channel State Information Reference signal, CSI-RS, a NZP CSI-RS or an SSB.
Sending 1901 the indication, e.g., the first indication. The first node 111 may be configured to perform this sending action 1902, e.g. by means of a sending unit 1701 within the first node 111, configured to perform this action. The receiving unit 1701 may be a processor 1704 of the first node 111, or an application running on such processor.

The sending in this Action 1901 may be performed, e.g., via the first beam 121.

The first indication may be sent to the wireless device 130 operating in the wireless communications network 100.

The first indication may indicate that non-group based reporting is to be applied to any setting comprising the same first indication.

A setting may be understood as a configuration.

The setting may indicate how to report, to a respective node 111, 112, information on a respective reference signal to be received from the respective node 111, 112 on a respective beam 121, 122. That is, the setting may be understood to be, or may be understood to be referred to as a “report setting” or “report configuration”. The report setting may be, for example, as described in 3GPP TS 38.331.

The respective node 111, 112 may be comprised in the set of nodes 110 comprising the first node 111 and at least the second node 112.

For example, the setting may indicate how to report, to the first node 111, information on a respective reference signal to be received from the first node 111 on the first beam 111.

The reference signal may be e.g., a Channel State Information Reference signal, CSI-RS.

Each of the respective nodes 111, 112, may be indicated by, or represented by, one of a: TRP, radio head, spatial relation, Transmission Configuration Indication state, Non-zero power Chanel State Information-Reference Signa resource set, Coresetpoolindex and an identifier.

For example, the first node 111, may be indicated by, or represented by, one of a first: TRP, radio head, spatial relation, Transmission Configuration Indication state, Non-zero power Chanel State Information-Reference Signal resource set, Coresetpoolindex and identifier.

The first indication may indicate an association between the respective reference signals on the respective beams 121, 122, and/or between report settings.

The first indication may indicate that the wireless device 130 is to ensure that the respective reference signals on the respective beams 121, 122 are enabled to be received in the same time and/or frequency resources, e.g., simultaneously, from the respective nodes 111, 112, by the wireless device 130, e.g., in different beams such as the first beam 121 and the second beam 122.

In some embodiments, the first indication may be a nonGroupBasedReportID, e.g., as described later.

The first indication may be comprised in the CSI report setting.

In some embodiments, the first indication may be comprised in the second indication.

The second indication may be a nonGroupBasedReportIE, e.g., as described later.

The second indication may be comprised in one of:
the CSI-ReportingConfig IE;
the CSI-AperiodicTriggerStateList information element; and
the CSI-MeasConfig information element.

In some embodiments, the second indication may further comprise one or more of:
the third indication, e.g., CoresetpoolIndex; the third indication may indicate which respective node 111, 112 the respective reference signal is transmitted from;
the fourth indication; the fourth indication may indicate timing information related to the non-group based reporting;
the fifth indication; the fifth indication may indicate the panel comprised in the wireless device 130 to be used to receive the respective reference signal; A panel may be e.g., an antenna array with dual polarized elements;
the sixth indication; the sixth indication may indicate the antenna group to be used by the wireless device 130 to measure the respective reference signal; and
the seventh indication; the seventh indication may indicate other characteristics for reporting the respective reference signal.

In some embodiments, the method may further comprise:
Receiving 1902 the report, e.g., the non-group based report. The first node 111 may be configured to perform this receiving action 1902, e.g. by means of a receiving unit 1702, configured to perform this action. The receiving unit 1702 may be a processor 1704 of the first node 111, or an application running on such processor.

The receiving in this Action 1902 may be from the wireless device 130. The receiving may be performed, e.g., via the first beam 121.

The report may report information regarding the one or more first respective reference signals received from the first node 111, that is, sent by the first node 111 and received by the wireless device 130. The report may comprise at least one of:
i. the eighth indication; the eight indication may indicate whether or not the one or more first respective reference signals are received using a same or a different panel comprised in the wireless device 130 than the panel used by the wireless device 130 to receive the one or more second respective reference signals from the second node 112;
ii. the ninth indication; the ninth indication may indicate the property, e.g., SI NR, RSRP, of the first respective reference signal sent by the first node 111, as measured by the wireless device 130, and
iii. the tenth indication; the tenth indication may indicate information based on the maximum permissible exposure of one of: a) the respective beam 121, 122, e.g., sent by the first node 111, and b) the first panel comprised in the wireless device 130.

Other units 1703 may be comprised in the first node 111.

In FIG. 17, optional units are indicated with dashed boxes.

### Selected Examples

Example 1. A method performed by a wireless device (130), the method being for handling a first indication, the wireless device (130) operating in the wireless communications network (100), the method comprising:
obtaining (1001) a first indication indicating that non-group based reporting is to be applied to any setting comprising the same first indication, wherein the setting indicates how to report, to a respective node (111, 112), information on a respective reference signal to be received from the respective node (111, 112) on a respective beam (121, 122), the respective node (111, 112) being comprised in a plurality of nodes (110) comprising a first node (111) and at least a second node (112).

Example 2. The method according to example 1, wherein the first indication indicates that the wireless device (130) is to ensure that the respective reference signals on the respective beams (121, 122) are enabled to be received in the same time and or frequency resources, e.g., simultaneously, from the respective nodes (111, 112), by the wireless device (130), e.g., in different beams.

Example 3. The method according to any of examples 1-2, wherein each of the respective nodes (111, 112), is indicated by one of a: TRP, radio head, spatial relation, Transmission Configuration Indication state, Non-zero power Chanel State Information-Reference Signa resource set, Coresetpoolindex and an identifier.

Example 4. The method according to any of examples 1-3, wherein the first indication is a nonGroupBasedReportl D.

Example 5. The method according to any of examples 1-4, wherein the first indication is comprised in a CSI report setting.

Example 6. The method according to any of examples 1-5, wherein the first indication is comprised in a second indication.

Example 7. The method according to example 6, wherein the second indication is a nonGroupBasedReportIE.

Example 8. The method according to any of examples 6-7, wherein the second indication is comprised in one of:
a CSI-ReportingConfig IE;
a CSI-AperiodicTriggerStateList information element; and
a CSI-MeasConfig information element.

Example 9. The method according to any of examples any of examples 6-8, wherein the second indication further comprises one or more of:
a third indication, e.g., CoresetpoolIndex, indicating which respective node (111, 112) the respective reference signal is transmitted from;
a fourth indication indicating timing information related to the non-group based reporting;
a fifth indication indicating a panel comprised in the wireless device (130) to be used to receive the respective reference signal;
a sixth indication indicating an antenna group to be used by the wireless device (130) to measure the respective reference signal; and
a seventh indication indicating other characteristics for reporting the respective reference signal.

Example 10. The method according to any of examples 1-9, wherein the method further comprises:
sending (1002) a non-group based report to the first node (111), the report reporting information regarding one or more first respective reference signals received from the first node (111), the report comprising at least one of:
   i. an eighth indication indicating whether or not the one or more first respective reference signals are received using a same or a different panel comprised in the wireless device (130) than a panel used by the wireless device (130) to receive one or more second respective reference signals from the second node (112);
   ii. a ninth indication indicating a property, e.g., SINR, RSRP, of the first respective reference signal received from the first node (111), as measured by the wireless device (130), and
   iii. a tenth indication indicating information based on a maximum permissible exposure of one of: a) a respective beam (121, 122), e.g., received by the wireless device (130), b) a first panel comprised in the wireless device (130).

Example 11. A method performed by a first node (111), the method being for handling a first indication, the first node (111) operating in the wireless communications network (100), the method comprising:
sending (1101) a first indication to a wireless device (130) operating in the wireless communications network (100), the first indication indicating that non-group based reporting is to be applied to any setting comprising the same first indication, wherein the setting indicates how to report, to a respective node (111, 112), information on a respective reference signal to be received from the respective node (111, 112) on a respective beam (121, 122), the respective node (111, 112) being comprised in a plurality of nodes (110) comprising a first node (111) and at least a second node (112).

Example 12. The method according to example 11, wherein the first indication indicates that the wireless device (130) is to ensure that the respective reference signals on the respective beams (121, 122) are enabled to be received in the same time and or frequency resources, e.g., simultaneously, from the respective nodes (111, 112), by the wireless device (130), e.g., in different beams.

Example 13. The method according to any of examples 11-12, wherein each of the respective nodes (111, 112), is indicated by one of a: TRP, radio head, spatial relation, Transmission Configuration Indication state, Non-zero power Chanel State Information-Reference Signal resource set, Coresetpoolindex and an identifier.

Example 14. The method according to any of examples 11-13, wherein the first indication is a nonGroupBasedReportl D.

Example 15. The method according to any of examples 11-14, wherein the first indication is comprised in a Chanel State Information, CSI, report setting.

Example 16. The method according to any of examples 11-15, wherein the first indication is comprised in a second indication.

Example 17. The method according to example 16, wherein the second indication is a nonGroupBasedReportIE.

Example 18. The method according to any of examples 16-17, wherein the second indication is comprised in one of:
a CSI-ReportingConfig IE;
a CSI-AperiodicTriggerStateList information element; and
a CSI-MeasConfig information element.

Example 19. The method according to any of examples any of examples 16-18, wherein the second indication further comprises one or more of:
a third indication, e.g., CoresetpoolIndex, indicating which respective node (111, 112) the respective reference signal is transmitted from;
a fourth indication indicating timing information related to the non-group based reporting;
a fifth indication indicating a panel comprised in the wireless device (130) to be used to receive the respective reference signal;
a sixth indication indicating an antenna group to be used by the wireless device (130) to measure the respective reference signal; and
a seventh indication indicating other characteristics for reporting the respective reference signal.

Example 20. The method according to any of examples 1-19, wherein the method further comprises:
receiving (1102) a non-group based report from the wireless device (130), the report reporting information regarding one or more first respective reference signals received from the first node (111), the report comprising at least one of:
   i. an eighth indication indicating whether or not the one or more first respective reference signals are received by the wireless device (130) using a same or a different panel comprised in the wireless device (130) than a panel used by the wireless device (130) to receive one or more second respective reference signals from the second node (112);
   ii. a ninth indication indicating a property, e.g., SINR, RSRP, of the first respective reference signal sent by the first node (111), as measured by the wireless device (130), and
   iii. a tenth indication indicating information based on a maximum permissible exposure of one of: a) a respective beam (121, 122), e.g., sent by the first node (111), and b) a first panel comprised in the wireless device (130).

### Further Extensions and Variations

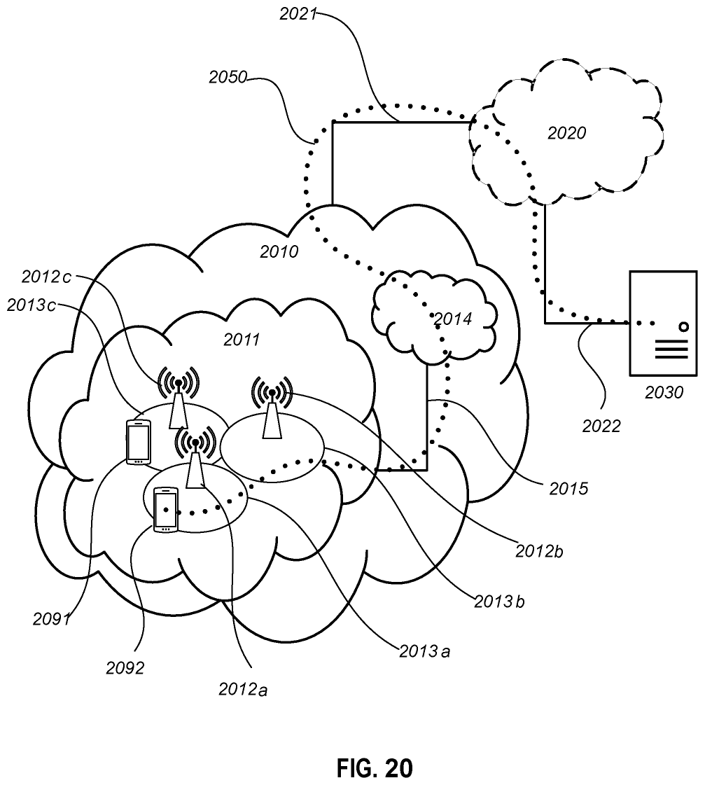

FIG. 20: Telecommunication network connected via an intermediate network to a host computer in accordance with some embodiments With reference to FIG. 20, in accordance with an embodiment, a communication system includes telecommunication network 2010 such as the wireless communications network 100, for example, a 3GPP-type cellular network, which comprises access network 2011, such as a radio access network, and core network 2014. Access network 2011 comprises a plurality of network nodes such as any of the first node 111, the second node 112, and/or the network node 110. For example, base stations 2012a, 2012b, 2012c, such as NBs, eNBs, gNBs or other types of wireless access points, each defining a corresponding coverage area 2013a, 2013b, 2013c. Each base station 2012a, 2012b, 2012c is connectable to core network 2014 over a wired or wireless connection 2015. A plurality of wireless devices, such as the wireless device 130 are comprised in the wireless communications network 100. In FIG. 20, a first UE 2091 located in coverage area 2013c is configured to wirelessly connect to, or be paged by, the corresponding base station 2012c. A second UE 2092 in coverage area 2013a is wirelessly connectable to the corresponding base station 2012a. While a plurality of UEs 2091, 2092 are illustrated in this example, the disclosed embodiments are equally applicable to a situation where a sole UE is in the coverage area or where a sole UE is connecting to the corresponding base station 2012. Any of the UEs 2091, 2092 are examples of the wireless device 130.

Telecommunication network 2010 is itself connected to host computer 2030, which may be embodied in the hardware and/or software of a standalone server, a cloud-implemented server, a distributed server or as processing resources in a server farm. Host computer 2030 may be under the ownership or control of a service provider, or may be operated by the service provider or on behalf of the service provider. Connections 2021 and 2022 between telecommunication network 2010 and host computer 2030 may extend directly from core network 2014 to host computer 2030 or may go via an optional intermediate network 2020. Intermediate network 2020 may be one of, or a combination of more than one of, a public, private or hosted network; intermediate network 2020, if any, may be a backbone network or the Internet; in particular, intermediate network 2020 may comprise two or more sub-networks (not shown).

The communication system of FIG. 20 as a whole enables connectivity between the connected UEs 2091, 2092 and host computer 2030. The connectivity may be described as an over-the-top (OTT) connection 2050. Host computer 2030 and the connected UEs 2091, 2092 are configured to communicate data and/or signaling via OTT connection 2050, using access network 2011, core network 2014, any intermediate network 2020 and possible further infrastructure (not shown) as intermediaries. OTT connection 2050 may be transparent in the sense that the participating communication devices through which OTT connection 2050 passes are unaware of routing of uplink and downlink communications. For example, base station 2012 may not or need not be informed about the past routing of an incoming downlink communication with data originating from host computer 2030 to be forwarded (e.g., handed over) to a connected UE 2091. Similarly, base station 2012 need not be aware of the future routing of an outgoing uplink communication originating from the UE 2091 towards the host computer 2030.

In relation to FIGS. 21, 22, 23, 24, and 25, which are described next, it may be understood that a UE is an example of the wireless device 130, and that any description provided for the UE equally applies to the wireless device 130. It may be also understood that the base station is an example of any of the first node 111, the second node 112, and/or the network node 110, and that any description provided for the base station equally applies to any of the first node 111, the second node 112, and/or the network node 110.

### FIG. 21: Host Computer Communicating Via a Base Station with a User Equipment Over a Partially Wireless Connection in Accordance with Some Embodiments

Example implementations, in accordance with an embodiment, of the wireless device 130, e.g., a UE, any of the first node 111, the second node 112, and/or the network node 110, e.g., a base station and host computer discussed in the preceding paragraphs will now be described with reference to FIG. 21. In communication system 2100, such as the wireless communications network 100, host computer 2110 comprises hardware 2115 including communication interface 2116 configured to set up and maintain a wired or wireless connection with an interface of a different communication device of communication system 2100. Host computer 2110 further comprises processing circuitry 2118, which may have storage and/or processing capabilities. In particular, processing circuitry 2118 may comprise one or more programmable processors, application-specific integrated circuits, field programmable gate arrays or combinations of these (not shown) adapted to execute instructions. Host computer 2110 further comprises software 2111, which is stored in or accessible by host computer 2110 and executable by processing circuitry 2118. Software 2111 includes host application 2112. Host application 2112 may be operable to provide a service to a remote user, such as UE 2130 connecting via OTT connection 2150 terminating at UE 2130 and host computer 2110. In providing the service to the remote user, host application 2112 may provide user data which is transmitted using OTT connection 2150.

Communication system 2100 further includes any of the first node 111, the second node 112, and/or the network node 110, exemplified in FIG. 21 as a base station 2120 provided in a telecommunication system and comprising hardware 2125 enabling it to communicate with host computer 2110 and with UE 2130. Hardware 2125 may include communication interface 2126 for setting up and maintaining a wired or wireless connection with an interface of a different communication device of communication system 2100, as well as radio interface 2127 for setting up and maintaining at least wireless connection 2170 with the wireless device 130, exemplified in FIG. 21 as a UE 2130 located in a coverage area (not shown in FIG. 21) served by base station 2120. Communication interface 2126 may be configured to facilitate connection 2160 to host computer 2110. Connection 2160 may be direct or it may pass through a core network (not shown in FIG. 21) of the telecommunication system and/or through one or more intermediate networks outside the telecommunication system. In the embodiment shown, hardware 2125 of base station 2120 further includes processing circuitry 2128, which may comprise one or more programmable processors, application-specific integrated circuits, field programmable gate arrays or combinations of these (not shown) adapted to execute instructions. Base station 2120 further has software 2121 stored internally or accessible via an external connection.

Communication system 2100 further includes UE 2130 already referred to. Its hardware 2135 may include radio interface 2137 configured to set up and maintain wireless connection 2170 with a base station serving a coverage area in which UE 2130 is currently located. Hardware 2135 of UE 2130 further includes processing circuitry 2138, which may comprise one or more programmable processors, application-specific integrated circuits, field programmable gate arrays or combinations of these (not shown) adapted to execute instructions. UE 2130 further comprises software 2131, which is stored in or accessible by UE 2130 and executable by processing circuitry 2138. Software 2131 includes client application 2132. Client application 2132 may be operable to provide a service to a human or non-human user via UE 2130, with the support of host computer 2110. In host computer 2110, an executing host application 2112 may communicate with the executing client application 2132 via OTT connection 2150 terminating at UE 2130 and host computer 2110. In providing the service to the user, client application 2132 may receive request data from host application 2112 and provide user data in response to the request data. OTT connection 2150 may transfer both the request data and the user data. Client application 2132 may interact with the user to generate the user data that it provides.

It is noted that host computer 2110, base station 2120 and UE 2130 illustrated in FIG. 21 may be similar or identical to host computer 2030, one of base stations 2012a, 2012b, 2012c and one of UEs 2091, 2092 of FIG. 20, respectively. This is to say, the inner workings of these entities may be as shown in FIG. 21 and independently, the surrounding network topology may be that of FIG. 20.

In FIG. 21, OTT connection 2150 has been drawn abstractly to illustrate the communication between host computer 2110 and UE 2130 via base station 2120, without explicit reference to any intermediary devices and the precise routing of messages via these devices. Network infrastructure may determine the routing, which it may be configured to hide from UE 2130 or from the service provider operating host computer 2110, or both. While OTT connection 2150 is active, the network infrastructure may further take decisions by which it dynamically changes the routing (e.g., on the basis of load balancing consideration or reconfiguration of the network).

Wireless connection 2170 between UE 2130 and base station 2120 is in accordance with the teachings of the embodiments described throughout this disclosure. One or more of the various embodiments improve the performance of OTT services provided to UE 2130 using OTT connection 2150, in which wireless connection 2170 forms the last segment. More precisely, the teachings of these embodiments may improve the latency, signalling overhead, and service interruption and thereby provide benefits such as reduced user waiting time, better responsiveness and extended battery lifetime.

A measurement procedure may be provided for the purpose of monitoring data rate, latency and other factors on which the one or more embodiments improve. There may further be an optional network functionality for reconfiguring OTT connection 2150 between host computer 2110 and UE 2130, in response to variations in the measurement results. The measurement procedure and/or the network functionality for reconfiguring OTT connection 2150 may be implemented in software 2111 and hardware 2115 of host computer 2110 or in software 2131 and hardware 2135 of UE 2130, or both. In embodiments, sensors (not shown) may be deployed in or in association with communication devices through which OTT connection 2150 passes; the sensors may participate in the measurement procedure by supplying values of the monitored quantities exemplified above, or supplying values of other physical quantities from which software 2111, 2131 may compute or estimate the monitored quantities. The reconfiguring of OTT connection 2150 may include message format, retransmission settings, preferred routing etc.; the reconfiguring need not affect base station 2120, and it may be unknown or imperceptible to base station 2120. Such procedures and functionalities may be known and practiced in the art. In certain embodiments, measurements may involve proprietary UE signaling facilitating host computer 2110's measurements of throughput, propagation times, latency and the like. The measurements may be implemented in that software 2111 and 2131 causes messages to be transmitted, in particular empty or ‘dummy’ messages, using OTT connection 2150 while it monitors propagation times, errors etc.

The wireless device 130 embodiments relate to FIG. 10, FIGS. 11-14, FIG. 16, and FIGS. 20-25.

The wireless device 130 may also be configured to communicate user data with a host application unit in a host computer 2110, e.g., via another link such as 2160.

The wireless device 130 may comprise an interface unit to facilitate communications between the wireless device 130 and other nodes or devices, e.g., the first node 111, the second node 112, and/or the network node 110, the host computer 2110, or any of the other nodes. In some particular examples, the interface may, for example, include a transceiver configured to transmit and receive radio signals over an air interface in accordance with a suitable standard.

The wireless device 130 may comprise an arrangement as shown in FIG. 16 or in FIG. 21.

The first node 111 embodiments relate to FIG. 15, FIGS. 11-14, FIGS. 17, and FIGS. 20-25.

The first node 111 may also be configured to communicate user data with a host application unit in a host computer 2110, e.g., via another link such as 2160.

The first node 111 may comprise an interface unit to facilitate communications between the first node 111 and other nodes or devices, e.g., the second node 112, the network node 110, the wireless device 130, the host computer 2110, or any of the other nodes. In some particular examples, the interface may, for example, include a transceiver configured to transmit and receive radio signals over an air interface in accordance with a suitable standard.

The first node 111 may comprise an arrangement as shown in FIG. 17 or in FIG. 21.

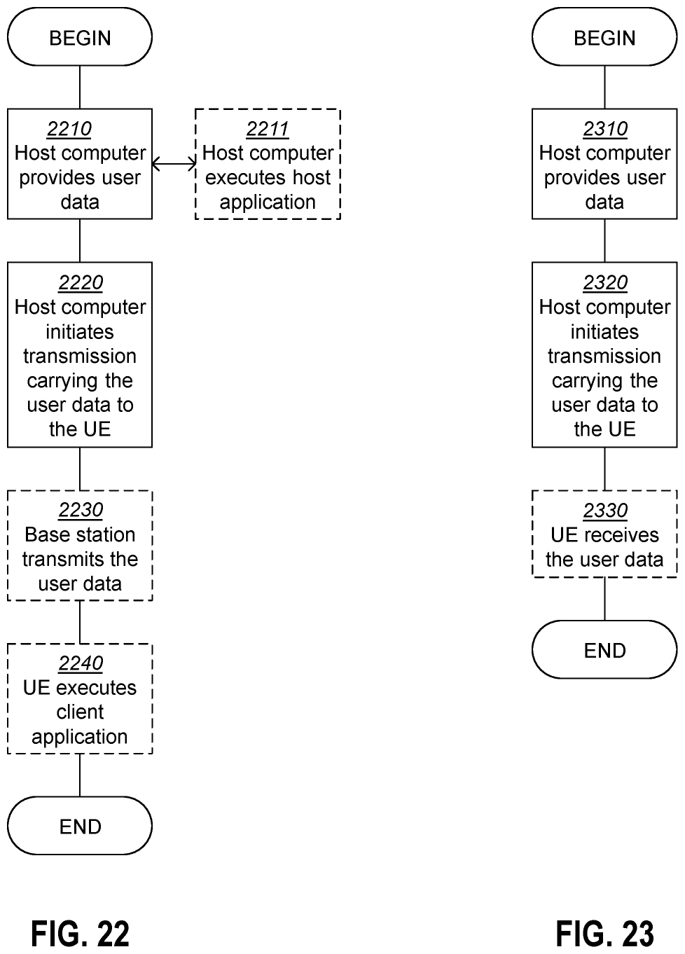

### FIG. 22: Methods Implemented in a Communication System Including a Host Computer, a Base Station and a User Equipment in Accordance with Some Embodiments

FIG. 22 is a flowchart illustrating a method implemented in a communication system, in accordance with one embodiment. The communication system includes a host computer, a base station and a UE which may be those described with reference to FIGS. 20 and 21. For simplicity of the present disclosure, only drawing references to FIG. 22 will be included in this section. In step 2210, the host computer provides user data. In substep 2211 (which may be optional) of step 2210, the host computer provides the user data by executing a host application. In step 2220, the host computer initiates a transmission carrying the user data to the UE. In step 2230 (which may be optional), the base station transmits to the UE the user data which was carried in the transmission that the host computer initiated, in accordance with the teachings of the embodiments described throughout this disclosure. In step 2240 (which may also be optional), the UE executes a client application associated with the host application executed by the host computer.

### FIG. 23: Methods Implemented in a Communication System Including a Host Computer, a Base Station and a User Equipment in Accordance with Some Embodiments

FIG. 23 is a flowchart illustrating a method implemented in a communication system, in accordance with one embodiment. The communication system includes a host computer, a base station and a UE which may be those described with reference to FIGS. 20 and 21. For simplicity of the present disclosure, only drawing references to FIG. 23 will be included in this section. In step 2310 of the method, the host computer provides user data. In an optional substep (not shown) the host computer provides the user data by executing a host application. In step 2320, the host computer initiates a transmission carrying the user data to the UE. The transmission may pass via the base station, in accordance with the teachings of the embodiments described throughout this disclosure. In step 2330 (which may be optional), the UE receives the user data carried in the transmission.

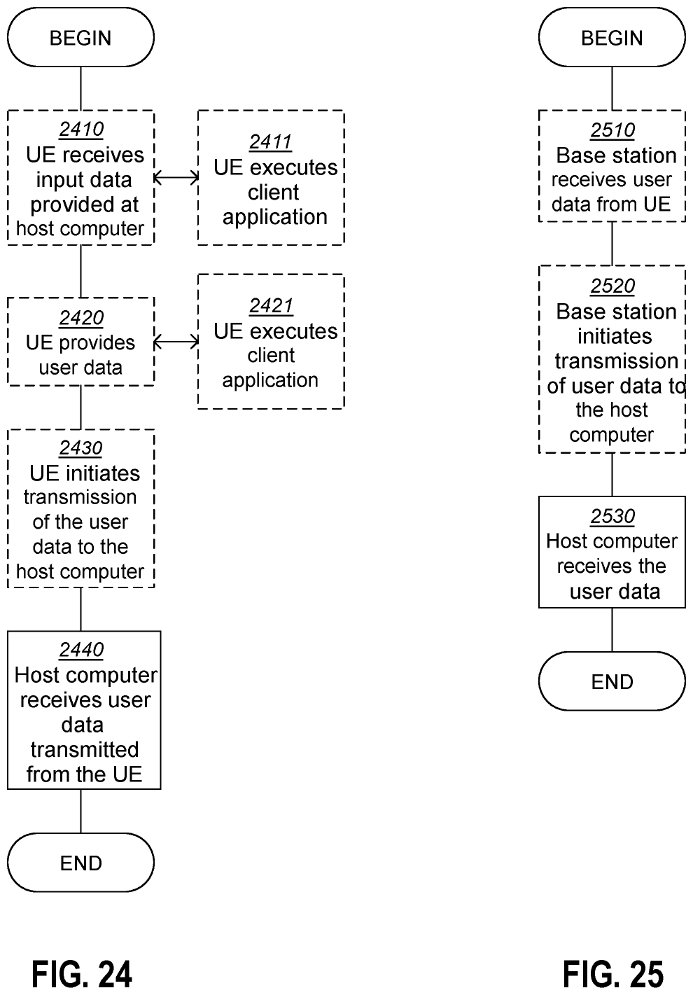

FIG. 24: Methods Implemented in a Communication System Including a Host Computer, a Base Station and a User Equipment in Accordance with Some Embodiments

FIG. 24 is a flowchart illustrating a method implemented in a communication system, in accordance with one embodiment. The communication system includes a host computer, a base station and a UE which may be those described with reference to FIGS. 20 and 21. For simplicity of the present disclosure, only drawing references to FIG. 24 will be included in this section. In step 2410 (which may be optional), the UE receives input data provided by the host computer. Additionally or alternatively, in step 2420, the UE provides user data. In substep 2421 (which may be optional) of step 2420, the UE provides the user data by executing a client application. In substep 2411 (which may be optional) of step 2410, the UE executes a client application which provides the user data in reaction to the received input data provided by the host computer. In providing the user data, the executed client application may further consider user input received from the user. Regardless of the specific manner in which the user data was provided, the UE initiates, in substep 2430 (which may be optional), transmission of the user data to the host computer. In step 2440 of the method, the host computer receives the user data transmitted from the UE, in accordance with the teachings of the embodiments described throughout this disclosure.

### FIG. 25: Methods Implemented in a Communication System Including a Host Computer, a Base Station and a User Equipment in Accordance with Some Embodiments

FIG. 25 is a flowchart illustrating a method implemented in a communication system, in accordance with one embodiment. The communication system includes a host computer, a base station and a UE which may be those described with reference to FIGS. 20 and 21. For simplicity of the present disclosure, only drawing references to FIG. 25 will be included in this section. In step 2510 (which may be optional), in accordance with the teachings of the embodiments described throughout this disclosure, the base station receives user data from the UE. In step 2520 (which may be optional), the base station initiates transmission of the received user data to the host computer. In step 2530 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

### Further Numbered Embodiments

1. A base station configured to communicate with a user equipment (UE), the base station comprising a radio interface and processing circuitry configured to perform one or more of the actions described herein as performed by any of the first node 111, the second node 112, and/or the network node 110.
5. A communication system including a host computer comprising:
   processing circuitry configured to provide user data; and
   a communication interface configured to forward the user data to a cellular network for transmission to a user equipment (UE),
   wherein the cellular network comprises a base station having a radio interface and processing circuitry, the base station's processing circuitry configured to perform one or more of the actions described herein as performed by any of the first node 111, the second node 112, and/or the network node 110.
6. The communication system of embodiment 5, further including the base station.
7. The communication system of embodiment 6, further including the UE, wherein the UE is configured to communicate with the base station.
8. The communication system of embodiment 7, wherein:
   the processing circuitry of the host computer is configured to execute a host application, thereby providing the user data; and
   the UE comprises processing circuitry configured to execute a client application associated with the host application.
11. A method implemented in a base station, comprising one or more of the actions described herein as performed by any of the first node 111, the second node 112, and/or the network node 110.
15. A method implemented in a communication system including a host computer, a base station and a user equipment (UE), the method comprising:
   at the host computer, providing user data; and
   at the host computer, initiating a transmission carrying the user data to the UE via a cellular network comprising the base station, wherein the base station performs one or more of the actions described herein as performed by any of the first node 111, the second node 112, and/or the network node 110.
16. The method of embodiment 15, further comprising:
   at the base station, transmitting the user data.
17. The method of embodiment 16, wherein the user data is provided at the host computer by executing a host application, the method further comprising:
   at the UE, executing a client application associated with the host application.
21. A user equipment (UE) configured to communicate with a base station, the UE comprising a radio interface and processing circuitry configured to perform one or more of the actions described herein as performed by the wireless device 130.
25. A communication system including a host computer comprising:
   processing circuitry configured to provide user data; and
   a communication interface configured to forward user data to a cellular network for transmission to a user equipment (UE), wherein the UE comprises a radio interface and processing circuitry, the UE's processing circuitry configured to perform one or more of the actions described herein as performed by the wireless device 130.
26. The communication system of embodiment 25, further including the UE.
27. The communication system of embodiment 26, wherein the cellular network further includes a base station configured to communicate with the UE.
28. The communication system of embodiment 26 or 27, wherein:
   the processing circuitry of the host computer is configured to execute a host application, thereby providing the user data; and
   the UE's processing circuitry is configured to execute a client application associated with the host application.
31. A method implemented in a user equipment (UE), comprising one or more of the actions described herein as performed by the wireless device 130.
35. A method implemented in a communication system including a host computer, a base station and a user equipment (UE), the method comprising:
   at the host computer, providing user data; and
   at the host computer, initiating a transmission carrying the user data to the UE via a cellular network comprising the base station, wherein the UE performs one or more of the actions described herein as performed by the wireless device 130.
36. The method of embodiment 35, further comprising:
   at the UE, receiving the user data from the base station.
41. A user equipment (UE) configured to communicate with a base station, the UE comprising a radio interface and processing circuitry configured to perform one or more of the actions described herein as performed by the wireless device 130.
45. A communication system including a host computer comprising:
   a communication interface configured to receive user data originating from a transmission from a user equipment (UE) to a base station, wherein the UE comprises a radio interface and processing circuitry, the UE's processing circuitry configured to: perform one or more of the actions described herein as performed by the wireless device 130.
   46. The communication system of embodiment 45, further including the UE.
47. The communication system of embodiment 46, further including the base station, wherein the base station comprises a radio interface configured to communicate with the UE and a communication interface configured to forward to the host computer the user data carried by a transmission from the UE to the base station.
48. The communication system of embodiment 46 or 47, wherein:
   the processing circuitry of the host computer is configured to execute a host application; and
   the UE's processing circuitry is configured to execute a client application associated with the host application, thereby providing the user data.
49. The communication system of embodiment 46 or 47, wherein:
   the processing circuitry of the host computer is configured to execute a host application, thereby providing request data; and
   the UE's processing circuitry is configured to execute a client application associated with the host application, thereby providing the user data in response to the request data.
51. A method implemented in a user equipment (UE), comprising one or more of the actions described herein as performed by the wireless device 130.
52. The method of embodiment 51, further comprising:
   providing user data; and
   forwarding the user data to a host computer via the transmission to the base station.
55. A method implemented in a communication system including a host computer, a base station and a user equipment (UE), the method comprising:
   at the host computer, receiving user data transmitted to the base station from the UE, wherein the UE performs one or more of the actions described herein as performed by the wireless device 130.
56. The method of embodiment 55, further comprising:
   at the UE, providing the user data to the base station.
57. The method of embodiment 56, further comprising:
   at the UE, executing a client application, thereby providing the user data to be transmitted; and
   at the host computer, executing a host application associated with the client application.
58. The method of embodiment 56, further comprising:
   at the UE, executing a client application; and
   at the UE, receiving input data to the client application, the input data being provided at the host computer by executing a host application associated with the client application,
   wherein the user data to be transmitted is provided by the client application in response to the input data.
61. A base station configured to communicate with a user equipment (UE), the base station comprising a radio interface and processing circuitry configured to perform one or more of the actions described herein as performed by any of the first node 111, the second node 112, and/or the network node 110.
65. A communication system including a host computer comprising a communication interface configured to receive user data originating from a transmission from a user equipment (UE) to a base station, wherein the base station comprises a radio interface and processing circuitry, the base station's processing circuitry configured to perform one or more of the actions described herein as performed by any of the first node 111, the second node 112, and/or the network node 110.
66. The communication system of embodiment 65, further including the base station.
67. The communication system of embodiment 66, further including the UE, wherein the UE is configured to communicate with the base station.
68. The communication system of embodiment 67, wherein:
   the processing circuitry of the host computer is configured to execute a host application;
   the UE is configured to execute a client application associated with the host application, thereby providing the user data to be received by the host computer.
71. A method implemented in a base station, comprising one or more of the actions described herein as performed by any of the first node 111, the second node 112, and/or the network node 110.
75. A method implemented in a communication system including a host computer, a base station and a user equipment (UE), the method comprising:
   at the host computer, receiving, from the base station, user data originating from a transmission which the base station has received from the UE, wherein the UE performs one or more of the actions described herein as performed by the wireless device 130.
76. The method of embodiment 75, further comprising:
   at the base station, receiving the user data from the UE.
77. The method of embodiment 76, further comprising:
   at the base station, initiating a transmission of the received user data to the host computer.

### REFERENCES

1. https://www.3g pp.org/ftp/tsg_ran/WG1_RL1/TSG R1_103-e/Inbox/drafts/8.1.2.3/Round %202/draft_R1_20 nnnnn_round2_MIMO2c_v038_mod.doc

1. A method performed by a wireless device, the method being for handling a first indication, the wireless device operating in a wireless communications network, the method comprising:
obtaining a first indication indicating that non-group based reporting is to be applied to any setting comprising the first indication, wherein the setting indicates how to report, to a respective node, information on one or more respective reference signals to be received from the respective node, wherein the reference signals use one or more respective beams of the respective node, wherein the respective node is comprised in a plurality of nodes comprising a first node and at least a second node,
performing measurements on the one or more respective signals received from the respective nodes, and
sending, based on the first indication, a non-group based report to the first node, the report comprising measurements on one or more first respective reference signals received from the first node, and based on the same first indication, sending another non-group based report to the second node, the another non-group based report comprising measurements on one or more second respective reference signals received from the second node.

2. The method according to claim 1, wherein each beam corresponds to a respective spatial filtering configuration of the respective node.

3. The method according to claim 2, wherein the first indication indicates that the wireless device is to ensure that the respective reference signals to be received, the respective reference signals using the respective spatial filtering configurations, are enabled to be received in the same time resources from the respective nodes, by the wireless device.

4. The method according to claim 1, wherein each of the respective nodes, is represented by one of a: Transmission and Reception Point (TRP) radio head, spatial relation, Transmission Configuration Indication state, Non-zero power Chanel State Information (CSI)-Reference Signal resource set, Coresetpoolindex and an identifier.

5. The method according to claim 1, wherein the first indication is a nonGroupBasedReportID.

6. The method according to claim 1, wherein the first indication is comprised in a CSI report setting.

7. The method according to claim 1, wherein the first indication is comprised in a second indication.

8. The method according to claim 7, wherein the second indication is an information element (IE) comprising at least an identifier (ID) indicating a non-group based report, and at least a third indication indicating which respective node the one or more respective reference signals are transmitted from.

9. The method according to claim 7, wherein the second indication is a nonGroupBasedReportIE.

10. The method according to claim 7, wherein the second indication is comprised in one of:
a CSI-ReportingConfig IE;
a CSI-AperiodicTriggerStateList information element; and
a CSI-MeasConfig information element.

11. The method according to claim 7, wherein the second indication further comprises one or more of:
a third indication indicating which respective node the one or more respective reference signals are transmitted from;
a fourth indication indicating timing information related to the non-group based reporting;
a fifth indication indicating a panel comprised in the wireless device to be used to receive the one or more respective reference signals;
a sixth indication indicating an antenna group to be used by the wireless device to measure the one or more respective reference signals; and
a seventh indication indicating other characteristics for reporting the one or more respective reference signals.

12. The method according to claim 11, wherein the timing information comprises a first maximum time, T, between a first time at which any one of the one or more respective reference signals from the respective node is measured by the wireless device and a second time, t, at which the non-group based report is sent by the wireless device to the respective node.

13. The method according to claim 12, wherein the timing information further comprises a a second maximum time, T₀, wherein the second maximum time is smaller than the first maximum time, and wherein any one of the one or more respective reference signals from the respective node is measured by the wireless device between the time interval (t-T) and (t-T₀).

14. The method according to claim 13, wherein the second maximum time, T₀, corresponds to a processing time or computing time needed by the wireless device to process or compute the non-group based report.

15. The method according to claim 1, wherein the report sent to the first node comprises at least one of:
i. an eighth indication indicating whether or not the one or more first respective reference signals are received using a same or a different panel comprised in the wireless device than a panel used by the wireless device to receive the one or more second respective reference signals from the second node;
ii. a ninth indication indicating a property of the one or more first respective reference signals received from the first node, as measured by the wireless device, and
iii. a tenth indication indicating information based on a maximum permissible exposure associated with one of: a) a respective reference signal using a respective spatial filtering configuration, and b) a first panel comprised in the wireless device 444, wherein a respective maximum permissible exposure is indicated per report.

16. The method according to claim 1, wherein the first node and the second node operate with a non-ideal backhaul between them, wherein a time difference between the signals received from the first node and the second node is larger than a duration of a cyclic prefix (CP) used by the wireless device.

17. A method performed by a first node, the method being for handling a first indication, the first node operating in a wireless communications network, the method comprising:
sending a first indication to a wireless device operating in the wireless communications network, the first indication indicating that non-group based reporting is to be applied to any setting comprising the first indication, wherein the setting indicates how to report, to a respective node, information on one or more respective reference signals to be received from the respective node, wherein the reference signals use one or more respective beams, of the respective node, wherein the respective node is comprised in a plurality of nodes comprising the first node and at least a second node, and
receiving, based on the first indication, a non-group based report from the wireless device, the report comprising measurements on one or more first respective reference signals transmitted by the first node, and wherein based on the same first indication, another non-group based report is sent to the second node by the wireless device, the another non-group based report comprising measurements on one or more second respective reference signals received by the wireless device from the second node.

18. The method according to claim 17, wherein each beam corresponds to a respective spatial filtering configuration of the respective node.

19. The method according to claim 18, wherein the first indication indicates that the wireless device is to ensure that the respective reference signals to be received, the respective reference signals using the respective spatial filtering configurations are enabled to be received in the same time resources from the respective nodes, by the wireless device.

20. The method according to claim 17,
wherein each of the respective nodes, is represented by one of a: Transmission and Reception Point, TRP, (TRP) radio head, spatial relation, Transmission Configuration Indication state, Non-zero power Chanel State Information, CSI, (CSI)-Reference Signal resource set, Coresetpoolindex and an identifier.

21. The method according to claim 17, wherein the first indication is a nonGroupBasedReportID.

22. The method according to claim 17, wherein the first indication is comprised in a Chanel State Information, CSI, (CSI) report setting.

23. The method according to claim 17, wherein the first indication is comprised in a second indication.

24. The method according to claim 23, wherein the second indication is an information element (IE) comprising at least an identifier (ID) indicating a non-group based report, and at least a third indication indicating which respective node the one or more respective reference signals are transmitted from.

25. The method according to claim 23 wherein the second indication is a nonGroupBasedReportIE.

26. The method according to claim 23, wherein the second indication is comprised in one of:
a CSI-ReportingConfig IE;
a CSI-AperiodicTriggerStateList information element; and
a CSI-MeasConfig information element.

27. The method according to claim 23, wherein the second indication further comprises one or more of:
a third indication indicating which respective node the one or more respective reference signals are transmitted from;
a fourth indication indicating timing information related to the non-group based reporting;
a fifth indication indicating a panel comprised in the wireless device to be used to receive the one or more respective reference signals;
a sixth indication indicating an antenna group to be used by the wireless device to measure the one or more respective reference signals; and
a seventh indication indicating other characteristics for reporting the one or more respective reference signals.

28. The method according to claim 27, wherein the timing information comprises a first maximum time, T, between a first time at which any one of the one or more respective reference signals from the respective node is measured by the wireless device and a second time, t, at which the non-group based report is sent by the wireless device to the respective node.

29. The method according to claim 28, wherein the timing information further comprises a second maximum time, T₀, wherein the second maximum time is smaller than the first maximum time, and wherein any one of the one or more respective reference signals from the respective node is to be measured by the wireless device between the time interval (t-T) and (t-T₀).

30. The method according to claim 29, wherein the second maximum time, T₀, corresponds to a processing time or computing time needed by the wireless device to process or compute the non-group based report.

31. The method according to claim 17, wherein the report received by the first node comprises at least one of:
i. an eighth indication indicating whether or not the one or more first respective reference signals are received by the wireless device using a same or a different panel comprised in the wireless device than a panel used by the wireless device to receive the one or more second respective reference signals from the second node;
ii. a ninth indication indicating a property of the one or more first respective reference signals sent by the first node, as measured by the wireless device, and
iii. a tenth indication indicating information based on a maximum permissible exposure associated with one of: a) a respective reference signal using a respective spatial filtering configuration, and b) a first panel comprised in the wireless device, wherein a respective maximum permissible exposure is indicated per report.

32. The method according to claim 17, wherein the first node and the second node operate with a non-ideal backhaul between them, wherein a time difference between the signals transmitted from the first node and the second node is larger than a duration of a cyclic prefix (CP) used by the wireless device.

33. A wireless device, for handling a first indication, the wireless device being configured to operate in a wireless communications network, the wireless device being further configured to:
obtain a first indication configured to indicate that non-group based reporting is to be applied to any setting comprising the first indication, wherein the setting is configured to indicate how to report, to a respective node, information on one or more respective reference signals configured to be received from the respective node, wherein the reference signals are configured to use one or more respective beams of the respective node, wherein the respective node is configured to be comprised in a plurality of nodes configured to comprise a first node and at least a second node,
perform measurements on the one or more respective signals configured to be received from the respective nodes, and
send, based on the first indication, a non-group based report to the first node, the report being configured to comprise measurements on one or more first respective reference signals configured to be received from the first node, and based on the same first indication, send another non-group based report to the second node, the another non-group based report being configured to comprise measurements on one or more second respective reference signals configured to be received from the second node.

34. The wireless device according to claim 33, wherein each beam is configured to correspond to a respective spatial filtering configuration of the respective node.

35. The wireless device according to claim 34, wherein the first indication is configured to indicate that the wireless device is to ensure that the respective reference signals configured to be received, the respective reference signals being configured to use the respective spatial filtering configurations, are enabled to be received in the same time resources from the respective nodes, by the wireless device.

36. The wireless device according to claim 34, wherein each of the respective nodes, is configured to be represented by one of a: Transmission and Reception Point (TRP) radio head, spatial relation, Transmission Configuration Indication state, Non-zero power Chanel State Information (CSI)-Reference Signal resource set, Coresetpoolindex and an identifier.

37. The wireless device according to claim 34, wherein the first indication is configured to be a nonGroupBasedReportID.

38. The wireless device according to claim 34, wherein the first indication is configured to be comprised in a CSI report setting.

39. The wireless device according to claim 34, wherein the first indication is configured to be comprised in a second indication.

40. The wireless device according to claim 39, wherein the second indication is configured to be an information element (IE) configured to comprise at least an identifier (ID) configured to indicate a non-group based report, and at least a third indication configured to indicate which respective node the one or more respective reference signals are transmitted from.

41. The wireless device according to claim 39, wherein the second indication is configured to be a nonGroupBasedReportIE.

42. The wireless device according to claim 39, wherein the second indication is configured to be comprised in one of:
a CSI-ReportingConfig IE;
a CSI-AperiodicTriggerStateList information element; and
a CSI-MeasConfig information element.

43. The wireless device according to claim 39, wherein the second indication is further configured to comprise one or more of:
a third indication configured to indicate which respective node the one or more respective reference signals are transmitted from;
a fourth indication configured to indicate timing information configured to be related to the non-group based reporting;
a fifth indication configured to indicate a panel configured to be comprised in the wireless device and configured to be used to receive the one or more respective reference signals;
a sixth indication configured to indicate an antenna group configured to be used by the wireless device to measure the one or more respective reference signals; and
a seventh indication configured to indicate other characteristics for reporting the one or more respective reference signals.

44. The wireless device according to claim 43, wherein the timing information is configured to comprise a first maximum time, T, between a first time at which any one of the one or more respective reference signals from the respective node is configured to be measured by the wireless device and a second time, t, at which the non-group based report is configured to be sent by the wireless device to the respective node.

45. The wireless device according to claim 44, wherein the timing information is further configured to comprise a second maximum time, T₀, wherein the second maximum time is configured to be smaller than the first maximum time, and wherein any one of the one or more respective reference signals from the respective node is configured to be measured by the wireless device between the time interval (t-T) and (t-T₀).

46. The wireless device according to claim 45, wherein the second maximum time, T₀, is configured to correspond to a processing time or computing time configured to be needed by the wireless device to process or compute the non-group based report.

47. The wireless device according to claim 34, wherein the report configured to be sent to the first node is configured to comprise at least one of:
i. an eighth indication configured to indicate whether or not the one or more first respective reference signals are configured to be received by the wireless device using a same or a different panel configured to be comprised in the wireless device than a panel configured to be used by the wireless device to receive the one or more second respective reference signals from the second node;
ii. a ninth indication configured to indicate a property of the one or more first respective reference signals configured to be received from the first node, as configured to be measured by the wireless device, and
iii. a tenth indication configured to indicate information based on a maximum permissible exposure configured to be associated with one of: a) a respective reference signal configured to be using a respective spatial filtering configuration, and b) a first panel configured to be comprised in the wireless device, wherein a respective maximum permissible exposure is configured to be indicated per report.

48. The wireless device according to claim 34, wherein the first node and the second node are configured to operate with a non-ideal backhaul between them, wherein a time difference between the signals configured to be received from the first node and the second node is configured to be larger than a duration of a cyclic prefix (CP) used by the wireless device.

49. A first node, for handling a first indication, the first node being configured to operate in a wireless communications network, the first node being further configured to:
send a first indication to a wireless device configured to operate in the wireless communications network, the first indication being configured to indicate that non-group based reporting is to be applied to any setting comprising the first indication, wherein the setting is configured to indicate how to report, to a respective node, information on one or more respective reference signals configured to be received from the respective node, wherein the reference signals are configured to use one or more respective beams, of the respective node, wherein the respective node
is configured to be comprised in a plurality of nodes configured to comprise the first node and at least a second node, and
receive, based on the first indication, a non-group based report from the wireless device, the report is configured to comprise measurements on one or more first respective reference signals configured to be transmitted by the first node, and wherein based on the same first indication, another non-group based report is configured to be sent to the second node by the wireless device, the another non-group based report being configured to comprise measurements on one or more second respective reference signals configured to be received by the wireless device from the second node.

50. The first node according to claim 49, wherein each beam is configured to correspond to a respective spatial filtering configuration of the respective node.

51. The first node according to claim 50, wherein the first indication is configured to indicate that the wireless device is to ensure that the respective reference signals configured to be received, the respective reference signals being configured to use the respective spatial filtering configurations, are enabled to be received in the same time resources from the respective nodes, by the wireless device.

52. The first node according to claim 49, wherein each of the respective nodes, is configured to be represented by one of a: Transmission and Reception Point (TRP) radio head, spatial relation, Transmission Configuration Indication state, Non-zero power Chanel State Information (CSI)-Reference Signal resource set, Coresetpoolindex and an identifier.

53. The first node according to claim 49, wherein the first indication is configured to be a nonGroupBasedReportID.

54. The first node according to claim 49, wherein the first indication is configured to be comprised in a Chanel State Information (CSI) report setting.

55. The first node according to claim 49, wherein the first indication is configured to be comprised in a second indication.

56. The first node according to claim 55, wherein the second indication is configured to be an information element (IE) configured to comprise at least an identifier (ID) configured to indicate a non-group based report, and at least a third indication configured to indicate which respective node the one or more respective reference signals are transmitted from.

57. The first node according to claim 55, wherein the second indication is configured to be a nonGroupBasedReportIE.

58. The first node according to claim 55, wherein the second indication is configured to be comprised in one of:
a CSI-ReportingConfig IE;
a CSI-AperiodicTriggerStateList information element; and
a CSI-MeasConfig information element.

59. The first node according to claim 55, wherein the second indication is further configured to comprise one or more of:
a third indication configured to indicate which respective node the one or more respective reference signals are transmitted from;
a fourth indication configured to indicate timing information configured to be related to the non-group based reporting;
a fifth indication configured to indicate a panel configured to be comprised in the wireless device and configured to be used to receive the one or more respective reference signals;
a sixth indication configured to indicate an antenna group configured to be used by the wireless device 30 to measure the one or more respective reference signals; and
a seventh indication configured to indicate other characteristics for reporting the one or more respective reference signals.

60. The first node according to claim 59, wherein the timing information is configured to comprise a first maximum time, T, between a first time at which any one of the one or more respective reference signals from the respective node is configured to be measured by the wireless device and a second time, t, at which the non-group based report is configured to be sent by the wireless device to the respective node.

61. The first node according to claim 60, wherein the timing information is further configured to comprise a) a second maximum time, T₀, wherein the second maximum time is configured to be smaller than the first maximum time, and wherein any one of the one or more respective reference signals from the respective node is configured to be measured by the wireless device between the time interval (t-T) and (t-T₀).

62. The first node according to claim 61, wherein the second maximum time, T₀, is configured to correspond to a processing time or computing time configured to be needed by the wireless device to process or compute the non-group based report.

63. The first node according to claim 49, wherein the report configured to be received by the first node is configured to comprise at least one of:
i. an eighth indication configured to indicate whether or not the one or more first respective reference signals are configured to be received by the wireless device using a same or a different panel configured to be comprised in the wireless device than a panel configured to be used by the wireless device to receive the one or more second respective reference signals from the second node;
ii. a ninth indication configured to indicate a property of the one or more first respective reference signals configured to be sent by the first node, as configured to be measured by the wireless device, and
iii. a tenth indication configured to indicate information based on a maximum permissible exposure configured to be associated with one of: a) a respective reference signal configured to be using a respective spatial filtering configuration, and b) a first panel configured to be comprised in the wireless device, wherein a respective maximum permissible exposure is configured to be indicated per report.

64. The first node according to claim 49, wherein the first node and the second node are configured to operate with a non-ideal backhaul between them, wherein a time difference between the signals configured to be transmitted from the first node and the second node is configured to be larger than a duration of a cyclic prefix (CP) used by the wireless device.
